(19) United States
(12) Patent Application Publication
(10) Pub. No.: US 2022/0386072 A1
(43) Pub. Date: Dec. 1, 2022

(54) DESCRIPTION LANDMARKS FOR RADIO MAPPING

(71) Applicant: HERE Global B.V., Eindhoven (NL)

(72) Inventors: Henri Jaakko Julius Nurminen, Tampere (FI); Pavel Ivanov, Tampere (FI); Marko Luomi, Lempaeaelae (FI)

(21) Appl. No.: 17/303,523

(22) Filed: Jun. 1, 2021

(51) Int. Cl. H04W 4/029; G01S 5/02

(52) U.S. Cl. CPC H04W 4/029; G01S 5/0284

(57) ABSTRACT

A mobile device generates a series of instances of space learning data. The series comprises instances of radio data captured as the device traverses a path through at least a portion of a space. Each instance of radio data describes a radio environment observed by the device at a respective location along the path. The device determines a position estimate based at least on motion of the device determined based on signals generated by motion sensors. The position estimate is associated with a respective instance of radio data. The device receives an message indicating the device is located proximate a particular landmark within the space. The landmark is a location within the space that is associated with a user-provided or sensor-defined landmark description. Responsive to receiving the message, the device updates the series to include an indication that a particular location along the path is proximate the particular landmark.

### TECHNOLOGICAL FIELD

An example embodiment relates to collecting a series of instances of space learning data. An example embodiment relates to generating a radio map based at least in part on a series of instances of space learning data.

### BACKGROUND

In various scenarios, global navigation satellite system (GNSS)-based positioning is not available and/or not accurate (e.g., indoors, in urban canyons, and/or the like). In such scenarios, radio-based positioning may be used. For example, a computing device may observe one or more network access points (e.g., cellular network access points, Wi-Fi network access points, Bluetooth network access points, and/or other radio frequency-based network access points) and, based on characteristics of the observations and the known location of the observed access points, a position estimate for the computing device may be determined.

However, in a variety of circumstances, the location of the access points must be learned. Areas where radio mapping is most advantageous are often areas where GNSS-based positioning is not available and/or not accurate. Therefore, accurately learning the location of access points within such spaces can be difficult.

### BRIEF SUMMARY

Various embodiments provide methods, apparatus, systems, and computer program products for using user-defined landmarks to aid in the learning of the location of access points within a space. In various embodiments, the user-defined landmarks within a space enable more accurate position estimates to be determined and associated with radio data captured within the space. The radio data and the associated position estimates may then be used to generate radio maps that may be used for radio-based positioning, a seeding of a radio map to be generated through crowd-sourced collection of additional radio data, and/or the like.

During a space learning process, a user carrying and/or otherwise physically coupled and/or associated with a mobile device moves around the space along a variety of trajectories and/or paths. As the mobile device is moved around the space, the mobile device captures instances of space learning data such that a series of instances of space learning data is collected. The space learning data may then be used to generate a radio map (e.g., a radio positioning map) of the space.

In various embodiments, the instances of space learning data comprise instances of radio data that are each associated with a position estimate and possibly a time stamp. In various embodiments, the radio data comprises an indication of one or more access points and/or radio nodes observed by the mobile device and may comprise information characterizing the observation of the access points and/or radio nodes by the mobile device. The terms access point and radio node are used interchangeably herein to refer to a device that emits a radio frequency signal. In various embodiments, the access points may comprise Wi-Fi access points, Bluetooth and/or Bluetooth lite access points, cellular access points (and/or cells), and/or other beacons and/or access points configured to emit radio frequency signals.

In various embodiments, a mobile device observes an access point by receiving, detecting, capturing, measuring, and/or the like a signal (e.g., a radio frequency signal) generated by the access point. For example, a mobile device may determine an access point identifier, a received signal strength, a one-way or round trip time for communicating with the access point, a transmission channel or frequency of the access point, a transmission interval (e.g., how frequently the access points generates, transmits, broadcasts, and/or the like a signal) and/or the like based on the mobile device's observation of the access point. The associated position estimate indicates the estimated position of the mobile device when the mobile device observed the one or more access points and/or radio nodes. The associated time stamp indicates the date and/or time when the mobile device observed the one or more access points and/or radio nodes.

In various embodiments, one or more landmarks are defined within a space such that the landmarks are known. In various embodiments, defining a landmark comprises generating a landmark description for the landmark. In various embodiments, the landmark description may comprise a textual description of the landmark provided by a user and/or a sensor-defined description. For example, the sensor-defined description may comprise a digital image of the landmark, a feature vector extracted from sensor data corresponding to the landmark, and/or other human and/or computer interpretable description of the landmark generated based on sensor data corresponding to the landmark. During a space learning process, a user carrying and/or otherwise physically coupled and/or associated with a mobile device may move through the space. As the user (and the mobile device) move through the space, the mobile device captures radio data and associates the radio data with position estimates. The position estimates, in various embodiments, are generated using a sensor fusion and/or motion-based process.

When it is determined (either automatically based on sensor data and/or responsive to receipt of user input indicating such) that the mobile device is located proximate a particular landmark of the known landmarks that have been defined, a landmark proximity indication indicating the mobile device's proximity to the particular landmark is added to the series of instances of space learning data. In an example embodiment, the particular landmark indication of the mobile device's proximity to the particular landmark is associated with an instance of radio data that was captured while the mobile device was proximate the particular landmark. In an example embodiment, the landmark proximity indication indicating the mobile device's proximity to the particular landmark is associated with a position estimate of the mobile device when the mobile device was proximate the particular landmark. In an example embodiment, the position estimate of the mobile device when the mobile device was proximate the particular landmark is generated using a sensor fusion and/or motion-based process.

In various embodiments, a sensor fusion and/or motion-based process is used to generate and/or determine position estimates for the mobile device as the mobile device moves through the space. In various embodiments, a sensor fusion and/or motion-based process uses one or more reference position (e.g., GNSS-based position determinations, detection that the mobile device is located at a reference position such as proximate a particular landmark, and/or the like) and motion sensor data (e.g., captured by one or more motion sensors of the mobile device) to track the path of a mobile device through a space. The path of the mobile device is anchored at the one or more reference positions and the motion sensor data is used to determine the path between anchoring reference positions as well as the timing of the movement of the mobile device along the path.

In various embodiments, the position of a landmark is not known when the landmark is defined. For example, defining the landmark comprises determining a first position estimate for the landmark and generating, receiving, defining, and/or the like a description of the landmark. In general, landmarks are chosen so that each landmark is unique and/or differentiable from any other location or feature within the space. Landmarks are generally also chosen so that, as the user moves around the space, the user (and the mobile device) will pass by the landmark multiple times during the space learning process. When it is detected that the mobile device is proximate a particular landmark, a landmark proximity indication indicating the mobile device's proximity to the particular landmark is added to the series of space learning data. In various embodiments, the landmark proximity indication indicating the mobile device's proximity to the particular landmark comprises and/or is associated with a position estimate of the mobile device at the moment when it is determined that the mobile device is proximate the particular landmark. Thus, the series of instances of space learning data comprises a plurality of position estimates for the location of the particular landmark.

A reference position for the particular landmark is determined based on a weighted average of at least some of the plurality of position estimates for the location of the particular landmark (possibly including the first position estimate for the particular landmark determined when the particular landmark was defined). The location of the particular landmark may then be used as a reference position for anchoring points of the path described by the series of instances of space learning data. Use of the location of the particular landmark as a reference position for anchoring points of the path enables the position estimates associated with instances of radio data to be refined and/or to be more accurately estimated so that the positions of the access points within the space and the radio environment within space can be more accurately determined and/or described.

The series of instances of space learning data, including the refined position estimates, may then be used to generate a radio map of the space. For example, the series of instances space learning data may be analyzed, processed, and/or the like to determine the location of access points within the space, to determine a characterization and/or description of the radio environment (e.g., the radio signals) within the space, and/or the like. A radio map may then be generated that includes information/data regarding the location of access points within the space, characterizations and/or descriptions of the radio environment at various positions within the space and/or the like. For example, the radio map may be used to perform radio-based positioning of a computing device within the space.

In various embodiments, the space is an indoor space and/or an outdoor space. In various embodiments, the space is a multi-leveled space. For example, the space may be a parking garage, a building having one or more floors, and/or the like. In various embodiments, the space comprises and/or is defined/demarcated by a building and/or a venue.

Thus, various embodiments provide technical solutions to the technical problems of determining a location of an access point when information regarding the location of the access point is not directly available. Various embodiments provide technical solutions to the technical problems of accurately estimating the position of mobile device within a space where GNSS-based positioning is not available or sufficiently accurate. For example, various embodiments provide technical solutions to the technical problems of determining accurate sensor fusion and/or motion-based position estimates without requiring frequent (e.g., at least once every five to ten minutes) GNSS-based position anchoring. Various embodiments provide improved radio maps and/or radio maps where the positions associated with access point locations and/or observed radio data are more accurate.

In various embodiments, the technical solutions include the defining of landmarks within the space. In various embodiments, the location of the landmarks is determined based on a plurality of sensor fusion and/or motion-based position estimates such that the location of the landmarks can be accurately determined as the noise in the position estimates is averaged out. Additionally, example embodiments reduce the human error introduced into various space learning processes when user selection of a location of the user on a map of the space is used to track the mobile device location. Thus, various embodiments provide technical improvements and advantages to accurately determining the location of access points within a space and/or characterizing the radio environment within a space without requiring previous knowledge of access point locations.

In an example embodiment, a mobile device generates a series of instances of space learning data. The series of instances of space learning data comprises instances of radio data captured as the mobile device traverses a path through at least a portion of a space. Each instance of radio data describes a radio environment observed by the mobile device at a respective location along the path. For each respective location, the mobile device determines a position estimate based at least on motion of the mobile device determined based at least in part on signals generated by one or more motion sensors of the mobile device. The position estimate is associated with a respective instance of radio data in the series of instances of space learning data. The mobile device receives a message indicating that the mobile device is located proximate a particular landmark. The particular landmark is an arbitrary location within the space that is associated with at least one of a user-provided or sensor-defined landmark description. Responsive to receiving the message indicating that the mobile device is located proximate the particular landmark, the mobile device updates the series of instances of space learning data to include a landmark proximity indication indicating that a particular location along the path is proximate the particular landmark.

According to an aspect of the present disclosure, a method for generating a series of instances of space learning data is provided. In an example embodiment, the method comprises generating, by a mobile device, a series of instances of space learning data. The series of instances of space learning data comprises instances of radio data captured as the mobile device traverses a path through at least a portion of a space. Each instance of radio data describes a radio environment observed by the mobile device at a respective location along the path. The method further comprises determining, for each respective location, a position estimate based at least on motion of the mobile device. The motion of the mobile device is determined based at least in part on signals generated by one or more motion sensors of the mobile device. The position estimate is associated with a respective instance of radio data in the series of instances of space learning data. The method further comprises receiving a message indicating that the mobile device is located proximate a particular landmark. The particular landmark is an arbitrary location within the space that is associated with at least one of a user-provided or sensor-defined description. The method further comprises, responsive to receiving the message indicating that the mobile device is located proximate the particular landmark, updating the series of instances of space learning data to include a landmark proximity indication indicating that a particular location along the path is proximate the particular landmark.

In an example embodiment, prior to generating the series of instances of space learning data, the method comprises receiving user input via a user interface of the mobile device defining at least one of the one or more known landmarks. In an example embodiment, defining the at least one of the one or more known landmarks comprises generating a first position estimate of the at least one of the one or more known landmarks and generating the respective landmark description. In an example embodiment, the position estimate for a respective location is determined based on a portion of the path the mobile device traversed, wherein at least one end of the portion of the path is a known location and the portion of the path is determined based at least in part on the signals generated by the one or more motion sensors of the mobile device. In an example embodiment, the known location is one of (a) a location where a GNSS-based position estimate that satisfies one or more quality criteria is available or (b) proximate a known landmark of the one or more known landmarks as indicated by the received message. In an example embodiment, a position determination for a location of the particular landmark is determined by a weighted average of position estimates determined based at least in part on motion of the mobile device as determined based at least in part on the signals generated by the one or more motion sensors. In an example embodiment, the position estimate for the respective location is determined using a sensor fusion process.

In an example embodiment, the message indicating that the mobile device is located proximate the particular landmark is received responsive to user interaction with a user interface of the mobile device. In an example embodiment, the user interacts with the user interface by selecting a selectable user interface element of a graphical user interface displayed via the user interface of the mobile device, the selected selectable user interface element corresponding to the particular landmark. In an example embodiment, the selected selectable user interface element comprises at least one of an image or a text description of the particular landmark, the at least one of the image or the text description being at least a portion of the respective landmark description.

In an example embodiment, the message indicating that the mobile device is located proximate the particular landmark is received based on a determination that at least one sensor of the mobile device captured sensor data comprising the particular landmark based at least in part on the respective landmark description. In an example embodiment, the particular landmark is a text string or computer detectable feature that is unique within the space.

In an example embodiment, the space comprises a building or venue and the series of instances of space learning data are configured for use in preparing or updating a radio map of the building or venue. In an example embodiment, the radio map is configured for use as a radio-based positioning map.

According to another aspect of the present disclosure, a mobile device is provided. In an example embodiment, the mobile device comprises at least one processor, at least one memory storing computer program code and/or instructions, and one or more motion sensors. The at least one memory and the computer program code and/or instructions are configured to, with the processor, cause the mobile device to at least generate a series of instances of space learning data. The series of instances of space learning data comprises instances of radio data captured as the mobile device traverses a path through at least a portion of a space. Each instance of radio data describes a radio environment observed by the mobile device at a respective location along the path. The at least one memory and the computer program code and/or instructions are further configured to, with the processor, cause the mobile device to at least determine, for each respective location, a position estimate based at least on motion of the mobile device. The motion of the mobile device is determined based at least in part on signals generated by one or more motion sensors of the mobile device. The position estimate is associated with a respective instance of radio data in the series of instances of space learning data. The at least one memory and the computer program code and/or instructions are further configured to, with the processor, cause the mobile device to at least receive a message indicating that the mobile device is located proximate a particular landmark. The particular landmark is an arbitrary location within the space that is associated with at least one of a user-provided or sensor-defined description. The at least one memory and the computer program code and/or instructions are further configured to, with the processor, cause the mobile device to at least, responsive to receiving the message indicating that the mobile device is located proximate the particular landmark, update the series of instances of space learning data to include a landmark proximity indication indicating that a particular location along the path is proximate the particular landmark.

In an example embodiment, the at least one memory and the computer program code and/or instructions are further configured to, with the processor, cause the mobile device to at least, prior to generating the series of instances of space learning data, receive user input via a user interface of the mobile device defining at least one of the one or more known landmarks. In an example embodiment, defining the at least one of the one or more known landmarks comprises generating a first position estimate of the at least one of the one or more known landmarks and generating the respective landmark description. In an example embodiment, the position estimate for a respective location is determined based on a portion of the path the mobile device traversed, wherein at least one end of the portion of the path is a known location and the portion of the path is determined based at least in part on the signals generated by the one or more motion sensors of the mobile device. In an example embodiment, the known location is one of (a) a location where a GNSS-based position estimate that satisfies one or more quality criteria is available or (b) proximate a known landmark of the one or more known landmarks as indicated by the received message. In an example embodiment, a position determination for a location of the particular landmark is determined by a weighted average of position estimates determined based at least in part on motion of the mobile device as determined based at least in part on the signals generated by the one or more motion sensors. In an example embodiment, the position estimate for the respective location is determined using a sensor fusion process.

In an example embodiment, the message indicating that the mobile device is located proximate the particular landmark is received responsive to user interaction with a user interface of the mobile device. In an example embodiment, the user interacts with the user interface by selecting a selectable user interface element of a graphical user interface displayed via the user interface of the mobile device, the selected selectable user interface element corresponding to the particular landmark. In an example embodiment, the selected selectable user interface element comprises at least one of an image or a text description of the particular landmark, the at least one of the image or the text description being at least a portion of the respective landmark description.

In an example embodiment, the message indicating that the mobile device is located proximate the particular landmark is received based on a determination that at least one sensor of the mobile device captured sensor data comprising the particular landmark based at least in part on the respective landmark description. In an example embodiment, the particular landmark is a text string or computer detectable feature that is unique within the space.

In an example embodiment, the space comprises a building or venue and the series of instances of space learning data are configured for use in preparing or updating a radio map of the building or venue. In an example embodiment, the radio map is configured for use as a radio-based positioning map.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions configured, when executed by a processor of an apparatus, to cause the apparatus to generate a series of instances of space learning data. The series of instances of space learning data comprises instances of radio data captured as the mobile device traverses a path through at least a portion of a space. Each instance of radio data describes a radio environment observed by the mobile device at a respective location along the path. The computer-readable program code and/or instructions portions comprise executable portions further configured, when executed by a processor of an apparatus, to cause the apparatus to determine, for each respective location, a position estimate based at least on motion of the mobile device. The motion of the mobile device is determined based at least in part on signals generated by one or more motion sensors of the mobile device. The position estimate is associated with a respective instance of radio data in the series of instances of space learning data. The computer-readable program code and/or instructions portions comprise executable portions further configured, when executed by a processor of an apparatus, to cause the apparatus to receive a message indicating that the mobile device is located proximate a particular landmark. The particular landmark is an arbitrary location within the space that is associated with at least one of user-provided or sensor-defined description. The computer-readable program code and/or instructions portions comprise executable portions further configured, when executed by a processor of an apparatus, to cause the apparatus to, responsive to receiving the message indicating that the mobile device is located proximate the particular landmark, update the series of instances of space learning data to include a landmark proximity indication indicating that a particular location along the path is proximate the particular landmark.

In an example embodiment, the computer-readable program code and/or instructions portions comprise executable portions further configured, when executed by a processor of an apparatus, to cause the apparatus to, prior to generating the series of instances of space learning data, receive user input via a user interface of the mobile device defining at least one of the one or more known landmarks. In an example embodiment, defining the at least one of the one or more known landmarks comprises generating a first position estimate of the at least one of the one or more known landmarks and generating the respective landmark description. In an example embodiment, the position estimate for a respective location is determined based on a portion of the path the mobile device traversed, wherein at least one end of the portion of the path is a known location and the portion of the path is determined based at least in part on the signals generated by the one or more motion sensors of the mobile device. In an example embodiment, the known location is one of (a) a location where a GNSS-based position estimate that satisfies one or more quality criteria is available or (b) proximate a known landmark of the one or more known landmarks as indicated by the received message. In an example embodiment, a position determination for a location of the particular landmark is determined by a weighted average of position estimates determined based at least in part on motion of the mobile device as determined based at least in part on the signals generated by the one or more motion sensors. In an example embodiment, the position estimate for the respective location is determined using a sensor fusion process.

In an example embodiment, the message indicating that the mobile device is located proximate the particular landmark is received responsive to user interaction with a user interface of the mobile device. In an example embodiment, the user interacts with the user interface by selecting a selectable user interface element of a graphical user interface displayed via the user interface of the mobile device, the selected selectable user interface element corresponding to the particular landmark. In an example embodiment, the selected selectable user interface element comprises at least one of an image or a text description of the particular landmark, the at least one of the image or the text description being at least a portion of the respective landmark description.

In an example embodiment, the message indicating that the mobile device is located proximate the particular landmark is received based on a determination that at least one sensor of the mobile device captured sensor data comprising the particular landmark based at least in part on the respective landmark description. In an example embodiment, the particular landmark is a text string or computer detectable feature that is unique within the space.

In an example embodiment, the space comprises a building or venue and the series of instances of space learning data are configured for use in preparing or updating a radio map of the building or venue. In an example embodiment, the radio map is configured for use as a radio-based positioning map.

According to yet another aspect, an apparatus is provided. In an example embodiment, the apparatus comprises means for generating a series of instances of space learning data. The series of instances of space learning data comprises instances of radio data captured as the apparatus traverses a path through at least a portion of a space. Each instance of radio data describes a radio environment observed by the apparatus at a respective location along the path. The apparatus comprises means for determining, for each respective location, a position estimate based at least on motion of the apparatus. The motion of the apparatus is determined based at least in part on signals generated by one or more motion sensors of the apparatus. The position estimate is associated with a respective instance of radio data in the series of instances of space learning data. The apparatus comprises means for receiving a message indicating that the apparatus is located proximate a particular landmark. The particular landmark is an arbitrary location within the space that is associated with at least one of user-provided or sensor-defined description. The apparatus comprises means for, responsive to receiving the message indicating that the apparatus is located proximate the particular landmark, updating the series of instances of space learning data to include a landmark proximity indication indicating that a particular location along the path is proximate the particular landmark.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example system of one embodiment of the present disclosure;

FIG. 2A is a block diagram of a network device that may be specifically configured in accordance with an example embodiment;

FIG. 2B is a block diagram of a mobile device that may be specifically configured in accordance with an example embodiment;

FIG. 2C is a block diagram of a computing device that may be specifically configured in accordance with an example embodiment;

FIG. 3 is a flowchart illustrating operations performed, such as by the mobile device of FIG. 2B, in accordance with an example embodiment;

FIG. 4 is a flowchart illustrating operations performed, such as by the mobile device of FIG. 2B, in accordance with an example embodiment;

FIG. 5 is a flowchart illustrating operations performed, such as by the mobile device of FIG. 2B, in accordance with an example embodiment;

FIG. 6 is a flowchart illustrating operations performed, such as by the mobile device of FIG. 2B, in accordance with an example embodiment;

FIG. 7 is an example view of a graphical user interface provided via a user interface of the mobile device of FIG. 2B, in accordance with an example embodiment;

FIG. 8 is a flowchart illustrating operations performed, such as by the mobile device of FIG. 2B, in accordance with an example embodiment;

FIG. 9 is a flowchart illustrating operations performed, such as by the network device of FIG. 2A, in accordance with an example embodiment; and

FIG. 10 is a flowchart illustrating operations performed, such as by the computing device of FIG. 2C, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

### I. General Overview

Various embodiments provide methods, apparatus, systems, and computer program products for using user-defined landmarks to aid in the learning of the location of access points within a space. In various embodiments, the user-defined landmarks within a space enable more accurate position estimates to be determined and associated with radio data captured within the space. The radio data and the associated position estimates may then be used to generate radio maps that may be used for radio-based positioning, a seeding of a radio map to be generated through crowd-sourced collection of additional radio data, and/or the like.

During a space learning process, a user carrying and/or otherwise physically coupled and/or associated with a mobile device moves around the space along a variety of trajectories and/or paths. As the mobile device is moved around the space, the mobile device captures instances of space learning data such that a of series instances of space learning data is collected.

The space learning data may then be used to generate a radio map (e.g., a radio positioning map) of the space.

In various embodiments, the instances of space learning data comprise instances of radio data that are each associated with a position estimate and possibly a time stamp. In various scenarios, GNSS-based positioning is not available or sufficiently accurate for determining the position estimates of the instances of space learning data. Moreover, the space learning process is often being performed to determine the location of access points within the space and/or to characterize the radio environment within the space. Therefore, using radio-based positioning is likely not available or not sufficiently accurate within the space for determining the position estimates of the instances of space learning data. Thus, in a variety of space learning processes, sensor fusion and/or motion-based positioning is used to determine the position estimates of the instances of space learning data. However, sensor fusion and/or motion-based position estimates tend to become inaccurate when the mobile devices path through the space is not frequently anchored to a reference point. Often, a reference point is a GNSS-based positioning of a location just outside the space. For example, if the space is the inside of a building, the user may take the mobile device outside at least once every five to ten minutes so that a GNSS-based position estimate may be determined and to which the path of the mobile device can be anchored. However, an appropriate path and/or trajectory through the space that includes visiting a location where a GNSS-based position estimate may be determined at least every five to ten minutes may not be possible. For example, if the space is a large building, a path and/or trajectory through all parts of the building that includes visits to the outside of the building at least once every five to ten minute may not be possible. Various embodiments therefore provide a technical improvement by providing reference positions to which a path and/or trajectory through the space can be anchored to in order to enable accurate sensor fusion and/or motion-based position estimates. Thus, various embodiments, provide technical advantages enable the generation of more accurate radio maps.

In various embodiments, a space learning process comprises a user carrying and/or otherwise physically associated with and/or coupled to a mobile device traversing a path and/or trajectory through a space. As the mobile device moves through the space, the mobile devices captures instances of space learning data such that a series of instances of space learning data are collected. In various embodiments, the instances of space learning data comprise instances of radio data that are each associated with a respective position estimate and, possibly, a time stamp. In various embodiments, an instance of radio data comprises an indication of one or more access points observed by the mobile device and may comprise information characterizing the observation of the access points by the mobile device. In various embodiments, the access points comprise Wi-Fi access points, Bluetooth and/or Bluetooth lite access points, cellular access points (and/or cells), and/or other beacons and/or access points configured to emit radio frequency signals.

In various embodiments, the mobile device observes an access point by receiving, detecting, capturing, measuring, and/or the like a signal (e.g., a radio frequency signal) generated by the access point. For example, a mobile device may determine an access point identifier, a received signal strength, a one-way or round trip time for communicating with the access point, a transmission channel or frequency of the access point, a transmission interval (e.g., how frequently the access points generates, transmits, broadcasts, and/or the like a signal) and/or the like based on the mobile device's observation of the access point. The associated position estimate indicates the estimated position of the mobile device when the mobile device observed the one or more access points and/or radio nodes. The associated time stamp indicates the date and/or time when the mobile device observed the one or more access points and/or radio nodes.

In various embodiments, one or more landmarks are defined within a space for which a space learning process is to be performed such that one or more known landmarks are defined within the space. In various embodiments, defining a landmark comprises generating a landmark description for the landmark. In various embodiments, the landmark description may comprise a textual description of the landmark provided by a user and/or a sensor-defined description. For example, the sensor-defined description may comprise a digital image of the landmark, a feature vector extracted from sensor data corresponding to the landmark, and/or other human and/or computer interpretable description of the landmark generated based on sensor data corresponding to the landmark. In particular, the description is configured such that a user and/or the mobile device (e.g., by analyzing and/or processing sensor data) can unambiguously identify the landmark and/or determine when the mobile device is located in the vicinity, at, and/or proximate the landmark. During a space learning process, a user carrying and/or otherwise physically coupled to and/or associated with a mobile device may move through the space. As the user (and the mobile device) move through the space, the mobile device captures radio data and associates the radio data with position estimates. The position estimates, in various embodiments, are generated using a sensor fusion and/or motion-based process.

When it is determined (either automatically based on sensor data and/or responsive to receipt of user input indicating such) that the mobile device is located proximate a particular landmark of the known landmarks that have been defined, an indication of the mobile device's proximity to the particular landmark is added to the series of instances of space learning data. In an example embodiment, the indication of the mobile device's proximity to the particular landmark is associated with an instance of radio data that was captured while the mobile device was proximate the particular landmark. In an example embodiment, the indication of the mobile device's proximity to the particular landmark is associated with a position estimate of the mobile device when the mobile device was proximate the particular landmark. In an example embodiment, the position estimate of the mobile device when the mobile device was proximate the particular landmark is generated using a sensor fusion and/or motion-based process.

In various embodiments, a sensor fusion and/or motion-based process is used to generate and/or determine position estimates for the mobile device as the mobile device moves through the space. In various embodiments, a sensor fusion and/or motion-based process uses one or more reference position (e.g., GNSS-based position determinations, detection that the mobile device is located at a reference position such as proximate a particular landmark, and/or the like) and motion sensor data (e.g., captured by one or more motion sensors of the mobile device) to track the path of a mobile device through a space. The path of the mobile device is anchored at the one or more reference positions and the motion sensor data is used to determine the path between anchoring reference positions as well as the timing of the movement of the mobile device along the path.

In various embodiments, the position of a landmark is not known when the landmark is defined. For example, defining the landmark comprises determining a first position estimate for the landmark and generating, receiving, defining, and/or the like a description of the landmark. In general, landmarks are chosen so that each landmark is unique and/or differentiable from any other location or feature within the space. Landmarks are generally also chosen so that, as the user moves around the space, the user (and the mobile device) will pass by the landmark multiple times during the space learning process. When it is detected that the mobile device is proximate a particular landmark, an indication of the mobile device's proximity to the particular landmark is added to the series of space learning data. In various embodiments, the indication of the mobile device's proximity to the particular landmark comprises and/or is associated with a position estimate of the mobile device at the moment when it is determined that the mobile device is proximate the particular landmark. Thus, the series of instances of spaces learning data comprises a plurality of position estimates for the location of the particular landmark.

In various embodiments, a reference position for the particular landmark is determined based on the plurality of position estimates for the location of the particular landmark present in the series of instances of space learning data. For example, a reference position for the particular landmark is determined based on a weighted average of at least some of the plurality of position estimates for the location of the particular landmark (possibly including the first position estimate for the particular landmark determined when the particular landmark was defined), in various embodiments. The location of the particular landmark may then be used as a reference position for anchoring points of the path described by the series of instances of space learning data. Use of the location of the particular landmark as a reference position for anchoring points of the path enables the position estimates associated with instances of radio data to be refined and/or to be more accurately estimated (e.g., compared to when the particular landmark is not used as a reference position) so that the positions of the access points within the space and the radio environment within space can be more accurately determined and/or described.

The series of instances of space learning data, including the refined position estimates, may then be used to generate a radio map of the space. For example, the series of instances space learning data may be analyzed, processed, and/or the like to determine the location of access points within the space, to determine a characterization and/or description of the radio environment (e.g., the radio signals) within the space, and/or the like. A radio map may then be generated that includes information/data regarding the location of access points within the space, characterizations and/or descriptions of the radio environment at various positions within the space and/or the like. For example, the radio map may be used to perform radio-based positioning of a computing device within the space.

In various embodiments, the space is an indoor space and/or an outdoor space. In various embodiments, the space is a multi-leveled space. For example, the space may be a parking garage, a building having one or more floors, a venue, and/or the like. In various embodiments, the space comprises and/or is defined/demarcated by a building and/or a venue.

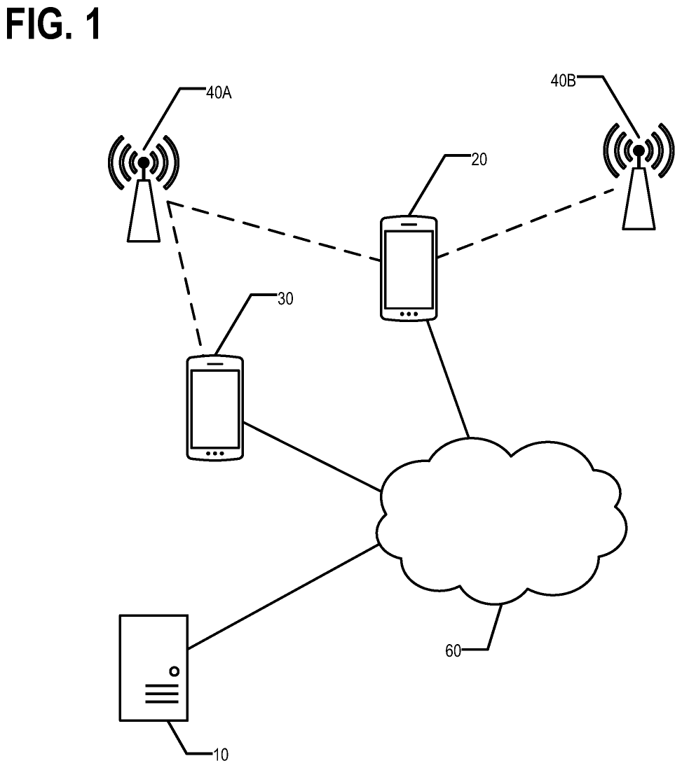

FIG. 1 provides an illustration of an example system that can be used in conjunction with various embodiments of the present invention. As shown in FIG. 1, the system includes one or more network devices 10, one or more mobile devices 20, one or more computing devices 30, one or more networks 60, and/or the like. In an example embodiment, the network device 10 is a server, group of servers, distributed computing system, part of a cloud-based computing system, and/or other computing system. In various embodiments, a mobile device 20 is a dedicated space learning data collection device (e.g., a mobile data gathering platform), a smartphone, a tablet, a personal digital assistant (PDA), and/or the like. In various embodiments, a computing device 20 is a smartphone, tablet, PDA, personal navigation device, and/or other mobile computing entity. In an example embodiment, a computing device 30 is configured to perform one or more positioning and/or navigation-related functions based on a radio map and/or a radio-based positioning estimate. In various embodiments, the network device 10 communicates with one or more mobile devices 20 and/or computing devices 30 via one or more wired or wireless networks 60.

In various embodiments, the system further includes one or more access points 40. In various embodiments, the access points 40 are wireless network access points and/or gateways such as Wi-Fi network access points, cellular network access points, Bluetooth access points, and/or other radio frequency-based network access points. In various embodiments, the access points may be other radio nodes, beacons, and/or the like, such as active radio frequency identifier (RFID) tags, and/or the like.

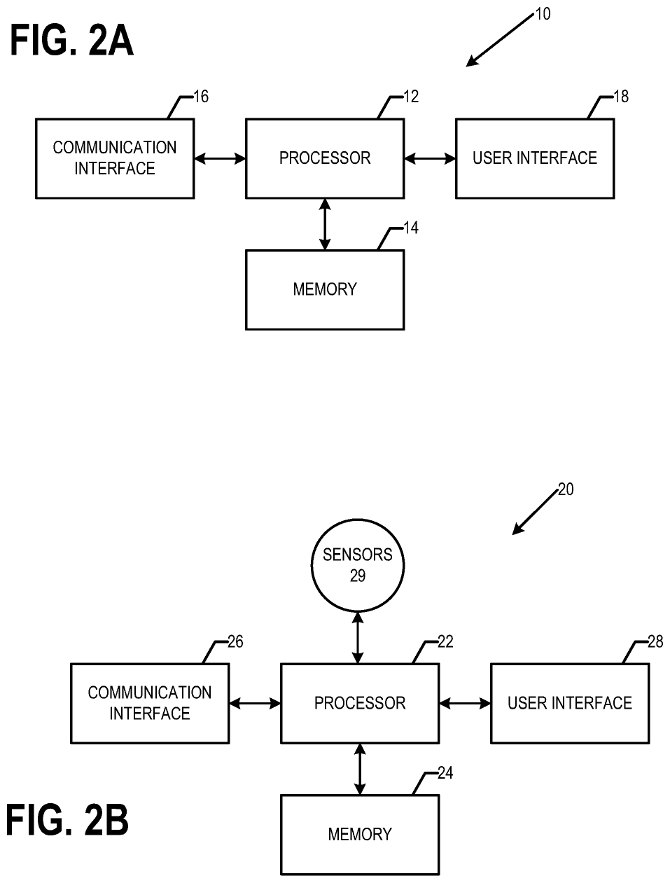

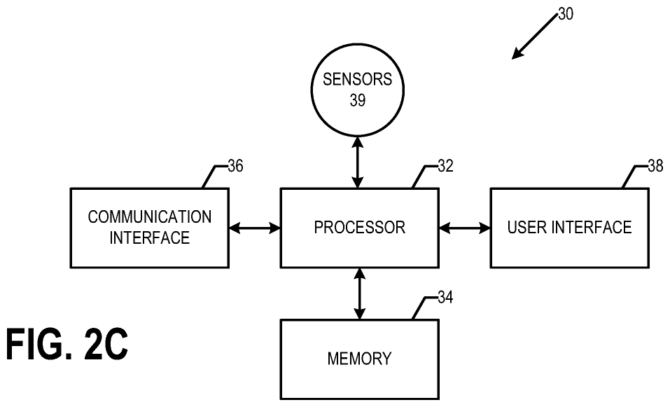

In an example embodiment, a network device 10 may comprise components similar to those shown in the example network device 10 diagrammed in FIG. 2A. In an example embodiment, the network device 10 is configured to obtain a series of instances of space learning data; determine and/or refine position estimates associated with instances of radio data of the series of instances of space learning data based on respective locations of one or more known landmarks and the presence of indications of the mobile device being proximate the one or more landmarks in the series of instances of space learning data; generate (e.g., create and/or update) a radio map based on the series of instances of space learning data; provide and/or use the radio map to perform positioning and/or navigation-related functions; and/or the like.

For example, as shown in FIG. 2A, the network device 10 may comprise a processor 12, memory 14, a user interface 18, a communications interface 16, and/or other components configured to perform various operations, procedures, functions, or the like described herein. In various embodiments, the network device 10 stores a geographical database, digital map, and/or positioning map, such as a radio map, computer program code and/or instructions for performing various functions described herein, and/or the like (e.g., in memory 14), for example. In at least some example embodiments, the memory 14 is non-transitory.

In an example embodiment, the mobile device 20 is configured to define one or more landmarks within a space, determine when the mobile device is located proximate a particular landmark and/or receive an indication of user input indicating the mobile device is located proximate the particular landmark, generate a series of instances of space learning data including one or more indications of the mobile device being proximate one or more particular landmarks, provide the series of instances of space learning data, and/or the like.

In an example embodiment, the mobile device 20 is a mobile computing device such as a mobile data gathering platform, smartphone, tablet, laptop, PDA, navigation system, an Internet of things (IoT) device, and/or the like. In an example embodiment, as shown in FIG. 2B, the mobile device 20 may comprise a processor 22, memory 24, a communications interface 26, a user interface 28, one or more sensors 29 and/or other components configured to perform various operations, procedures, functions or the like described herein. In various embodiments, the mobile device 20 stores at least a portion of one or more digital maps (e.g., geographic databases, positioning maps, radio maps, and/or the like) and/or computer executable instructions for generating and/or providing instances of access point observation information, and/or the like in memory 24. In at least some example embodiments, the memory 24 is non-transitory.

In various embodiments, the sensors 29 comprise one or more motion and/or IMU sensors, one or more GNSS sensors, one or more radio sensors, one or more image sensors, one or more audio sensors, and/or other sensors. In an example embodiment, the one or more motion and/or IMU sensors comprise one or more accelerometers, gyroscopes, magnetometers, barometers, and/or the like. In various embodiments, the one or more GNSS sensor(s) are configured to communicate with one or more GNSS satellites and determine GNSS-based position estimates and/or other information based on the communication with the GNSS satellites. In various embodiments, the one or more radio sensors comprise one or more radio interfaces configured to observe and/or receive signals generated and/or transmitted by one or more access points and/or other computing entities (e.g., access points 40). For example, the one or more interfaces may be configured (possibly in coordination with processor 22) to determine a locally unique identifier, globally unique identifier, and/or operational parameters of a network access point 40 observed by the radio sensor(s). As used herein, a radio sensor observes an access point 40 by receiving, capturing, measuring and/or observing a signal generated and/or transmitted by the access point 40. In an example embodiment, the interface of a radio sensor may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface(s) of the radio senor(s) may be configured to observe radio, millimeter, microwave, and/or infrared wavelength signals. In an example embodiment, the interface of a radio sensor may be coupled to and/or part of a communications interface 26. In various embodiments, the sensors 29 may further comprise one or more visual sensors configured to capture visual samples, such as digital camera(s), 3D cameras, 360° cameras, and/or image sensors. In various embodiments, the one or more sensors 29 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras. In various embodiments, the one or more sensors 29 comprise one or more audio sensors such as one or more microphones.

In an example embodiment, the computing device 30 is configured to capture instances of radio observation information, generate and/or receive a positioning estimate generated and/or determined using a radio map, perform one or more positioning and/or navigation-related functions based on the positioning estimate, and/or the like.

In an example embodiment, the computing device 30 is a mobile computing device such as a smartphone, tablet, laptop, PDA, navigation system, vehicle control system, an Internet of things (IoT) device, and/or the like. In an example embodiment, as shown in FIG. 2C, the computing device 30 may comprise a processor 32, memory 34, a communications interface 36, a user interface 38, one or more sensors 39 and/or other components configured to perform various operations, procedures, functions or the like described herein. In various embodiments, the computing device 30 stores at least a portion of one or more digital maps (e.g., geographic databases, positioning maps, radio maps, and/or the like) and/or computer executable instructions for generating and/or providing instances of radio observation information, and/or the like in memory 34. In at least some example embodiments, the memory 34 is non-transitory.

In various embodiments, the sensors 39 comprise one or more motion and/or IMU sensors, one or more GNSS sensors, one or more radio sensors, and/or other sensors. In an example embodiment, the one or more motion and/or IMU sensors comprise one or more accelerometers, gyroscopes, magnetometers, barometers, and/or the like. In various embodiments, the one or more GNSS sensor(s) are configured to communicate with one or more GNSS satellites and determine GNSS-based position estimates and/or other information based on the communication with the GNSS satellites. In various embodiments, the one or more radio sensors comprise one or more radio interfaces configured to observe and/or receive signals generated and/or transmitted by one or more access points and/or other computing entities (e.g., access points 40). For example, the one or more interfaces may be configured (possibly in coordination with processor 32) to determine a locally unique identifier, globally unique identifier, and/or operational parameters of a network access point 40 observed by the radio sensor(s). As used herein, a radio sensor observes an access point 40 by receiving, capturing, measuring and/or observing a signal generated and/or transmitted by the access point 40. In an example embodiment, the interface of a radio sensor may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface(s) of the radio senor(s) may be configured to observe radio, millimeter, microwave, and/or infrared wavelength signals. In an example embodiment, the interface of radio sensor may be coupled to and/or part of a communications interface 36. In various embodiments, the sensors 39 may further comprise one or more visual sensors configured to capture visual samples, such as digital camera(s), 3D cameras, 360° cameras, and/or image sensors. In various embodiments, the one or more sensors 39 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras.

Each of the components of the system may be in electronic communication with, for example, one another over the same or different wireless or wired networks 60 including, for example, a wired or wireless Personal Area Network (PAN), Local Area Network (LAN), Metropolitan Area Network (MAN), Wide Area Network (WAN), cellular network, and/or the like. In an example embodiment, a network 60 comprises the automotive cloud, digital transportation infrastructure (DTI), radio data system (RDS)/high definition (HD) radio or other digital radio system, and/or the like. For example, a mobile device 20 and/or a computing device 30 may be in communication with a network device 10 via the network 60. For example, a mobile device 20 and/or computing device 30 may communicate with the network device 10 via a network, such as the Cloud. For example, the Cloud may be a computer network that provides shared computer processing resources and data to computers and other devices connected thereto.

For example, the mobile device 20 captures a series of instances of space learning data and provides the series of instances of space learning data such that the network device 10 receives the series of instances of space learning data via the network 60. For example, the computing device 30 captures instances of radio observation information and provides the instances of radio observation information such that the network device 10 receives the instances of radio observation information via the network 60. For example, the computing device 30 receives positioning estimates and/or at least a portion of a radio map via the network 60. For example, the network device 10 may be configured to receive series of instances of space learning data and/or instances of radio observation information and/or provide positioning estimates and/or at least portions of a radio map via the network 60.

Certain example embodiments of the network device 10, mobile device 20, and computing device 30 are described in more detail below with respect to FIGS. 2A, 2B, and 2C.

### II. Example Operation(s)

In various embodiments, one or more landmarks are defined within a space for which a space learning process is to be performed so as to generate and/or form one or more known landmarks within the space. For example, a user may operate a mobile device 20 to define one or more landmarks within the space. The user may then move through the space on a planned or unplanned path and/or trajectory with the mobile device 20 while the mobile device captures instances of radio data, generates position estimates, and associates the instances of radio data with the respective position estimates. As the mobile device 20 moves through the space, the mobile device 20 monitors sensor data and/or at least one element of the user interface 28 to determine when the mobile device 20 is proximate a particular landmark of the one or more known landmarks (e.g., the landmarks that were defined within the space). When the mobile device 20 determines, based on monitoring sensor data captured by sensors 29 of the mobile device 20 and/or based on receipt of an indication of user input indicating that the mobile device 20 is located proximate the particular landmark, the mobile device 20 generates an indication that the mobile device is proximate the particular landmark and stores the indication as part of the series of instances of space learning data.

The mobile device 20 provides the series of instances of space learning data such that a network device 10 receives the series of instances of space learning data. The network device 10 analyzes and/or processes the series of instances of space learning data to generate (e.g., create and/or update) a radio map corresponding a geographic area comprising the space. The network device 10 may then provide at least a portion of the radio map and/or use the radio map to perform one or more positioning and/or navigation-related functions (e.g., based on radio observation information provided by a computing device 30).

Exemplary Defining Landmarks within the Space

In various embodiments, one or more landmarks are defined within a space such that the landmarks are known. In various embodiments, defining a landmark comprises generating a landmark description for the landmark. In various embodiments, the landmark description may comprise a textual description of the landmark (e.g., “bench in front of H&M”, “water fountain by first floor bathrooms,” etc.) provided by a user and/or a sensor-defined description. For example, the sensor-defined description may comprise a digital image of the landmark, a feature vector extracted from sensor data corresponding to the landmark, and/or other human and/or computer interpretable description of the landmark generated based on sensor data corresponding to the landmark. In various embodiments, defining the landmark comprises determining a first position estimate for the landmark. For example, a sensor fusion and/or motion-based process may be used to determine a first position estimate for the landmark.

In various embodiments, the one or more landmarks are defined prior to starting to generate the series of instances of space learning data. For example, the one or more landmarks may be defined weeks, days, hours, minutes, or seconds prior to starting to generate the series of instances of space learning data, in various embodiments. For example, the one or more landmarks are defined in a time period prior to beginning to generate the series of instances of space learning data but when the landmarks are not expected to appreciably change such that the user operating the mobile device 20 and/or one or more landmark identification applications (e.g., operating on the mobile device 20) configured to process sensor data captured by sensors 29 can still identify the defined landmarks based on their respective descriptions. In an example embodiment, the one or more landmarks are defined during a first pass through the space while generating the series of instances of space learning data.

As the user is passing through the space, the user looks around the space for locations or features that are unique and/or differentiable from other locations or features within the space. In an example embodiment, the user operates the mobile device to collect a stream of sensor data (e.g., digital images using a imaging sensors, point clouds using LiDAR and/or RADAR sensors, motion data via the motion and/or IMU sensors, and/or the like) via the sensors 29. One or more landmark identification applications (e.g., operating on the mobile device 20) process the stream of sensor data to identify locations or features that are unique and/or differentiable from other locations within the space. When a unique and/or differentiable location or feature is identified (e.g., by the user or by a landmark identification application) a landmark corresponding to the unique and/or differentiable location or feature is defined.

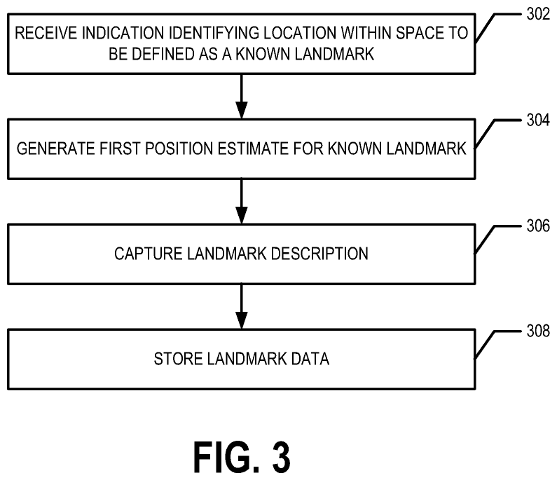

FIG. 3 provides a flowchart performed, for example, by a mobile device 20, to define a landmark, according to an example embodiment. Starting at block 302, an indication that a location is to be defined as a landmark is received. For example, the mobile device 20 receives an indication that the current location of the mobile device 20 is to be defined as a landmark. In another example, the mobile device 20 receives an indication that a particular location within the space (e.g., not necessarily the current location of mobile device 20) is to be defined as a landmark. For example, the user may interact with a graphical user interface (GUI) provided by the user interface 28 of the mobile device to provide user input indicating that the current location of the mobile device is to be defined as a landmark. The user interface 28 may provide the indication to the processor 22 and/or a landmark defining application being executed by the processor 22 so as to trigger a landmark definition process. In another example, when a landmark identification application identifies a location or feature as being unique or differentiable the landmark identification application provides an indication (e.g., to the processor 22 and/or a landmark defining application being executed by the processor 22) that the current location of the mobile device 20 is to be defined as a landmark. For example, the mobile device 20 comprises means, such as processor 22, memory 24, user interface 28, sensors 29, and/or the like, for receiving an indication that the current location of the mobile device 20 is to be defined as a landmark.

At block 304, a first position estimate for the landmark is generated. For example, the mobile device 20 generates a first position estimate for the landmark. For example, the mobile device 20 comprises means, such as processor 22, memory 24, sensors 29, and/or the like, for generating a first position estimate for the landmark. For example, a landmark defining application operating on the mobile device 20 may request (possibly via an application program interface (API) call) a position estimate for the current location of the mobile device 20 from a positioning engine (e.g., operating on the mobile device 20). The landmark defining application may then receive the position estimate from the positioning engine and assign the position estimate as the first position estimate for the landmark. In various embodiments, the first position estimate is generated (e.g., by the positioning engine operating on the mobile device 20) using a sensor fusion and/or motion-based algorithm. For example, the first position estimate may be determined based in part one or more reference and/or known locations (e.g., a last reliable GNSS-based position estimate prior to the mobile device 20 reaching the current location, a first reliable GNSS-based position estimate after the mobile device leaves the current location, and/or the like) and a path of the mobile device after leaving the reference and/or known location to reach the current location and/or from the current location to reach the reference and/or known location, as determined based on motion sensor data captured by motion and/or IMU sensors 29 of the mobile device 20. In another example, the first position estimate may be determined based in part on user input received via a user interface 28 of the mobile device 20 indicating a location of the landmark and/or a reference and/or known location. For example, the user may provide (e.g., via user input to the user interface 28) position coordinates, indicate a position on a geo-referenced map, and/or the like.

In an example embodiment, a first uncertainty, a first variance matrix, and/or first covariance matrix is also generated for the landmark as part of defining the landmark. In various embodiments, the uncertainty describes the spatial uncertainty and/or a confidence level for the first position estimate for the landmark. For example, the first uncertainty may indicate that there is a 99% chance that the location of the landmark is within three meters of the first position estimate, where the 99% provides a confidence level and the three meters provides the spatial uncertainty for the first position estimate. In an example embodiment, the first variance and/or covariance matrix is determined based at least on a variance and/or covariance of the position estimate used to generate the first position estimate (e.g., the GNSS-based position estimate, sensor fusion and/or motion-based position estimate, user input-based position estimate, and/or the like). In an example embodiment, the first variance and/or covariance matrix is determined based on a user-defined uncertainty value or a small constant value (e.g., within one meter with 99% probability, and/or the like).

At block 306, a landmark description is captured. For example, the mobile device 20 captures a landmark description. For example, the mobile device 20 comprises means, such as processor 22, memory 24, user interface 28, sensors 29, and/or the like, for capturing a landmark description. In an example embodiment, the user interacts with the GUI provided via the user interface 28 to provide a textual description of the landmark. For example, the user may type (e.g., via a soft or hard keyboard of the user interface 28) a textual description of the landmark. For example, the user may provide a description such as “the bench in front of store A,” “the information desk in front of the main entrance,” “below the main stairway,” and/or the like. In particular, the textual description enables the user to identify the landmark from any other location or feature within the space. In an example embodiment, the description of the landmark is a digital image of the landmark. For example, the user may operate the mobile device 20 to capture a digital image (e.g., using image sensors 29) of the landmark. In another example, one or more landmark identification applications (e.g., operating on the mobile device 20) may provide sensor data and/or a result of processing sensor data (e.g., a feature vector and/or the like) that may be used to distinguish the landmark (e.g., through the processing of sensor data) from other locations or features within the space as the landmark description.

At block 308, the landmark data is stored. For example, the mobile device 20 stores the landmark data. For example, the mobile device 20 comprises means, such as processor 22, memory 24, and/or the like, for storing the landmark data. In various embodiments, the landmark data comprises the first position estimate for the landmark (and may later include subsequent position estimates for the landmark) and the landmark description. For example, the landmark data is stored such that the landmark description may be used to identify when the mobile device 20 is proximate the landmark during a space learning process and first position estimate (and possibly additional position estimates) for the landmark may be used to determine or learn a location of the landmark that may be used as a reference and/or known location during the processing and/or analyzing of the series of space learning data corresponding to the space comprising the landmark. In various embodiments, each landmark is assigned a landmark identifier that may be used to identify the landmark and the landmark identifier is stored in association with the landmark data.

Exemplary Performing of a Space Learning Process

In various embodiments, a space learning process is performed by a user carrying or otherwise physically associated and/or coupled to a mobile device 20 moving through the space. For example, the user (and the mobile device 20) may make one or more (e.g., several) passes through various portions of the space. For example, the user (and the mobile device 20) may make at least one pass through each portion of the space. For example, the user (and the mobile device 20) may traverse each hallway, walkway, and/or the like of the space at least once while generating instances of space learning data. In various embodiments, the instances of space learning data are a series of space learning data that describe the path the mobile device 20 traveled through, around, and/or within the space. For example, the instances of space learning data may be time ordered to describe a path of the mobile device 20 as the mobile device 20 traversed through, around, and/or within the space. In various embodiments, the instances of space learning data comprise instances of radio data that comprise and/or are associated with respective position estimates. In various embodiments, the instances of space learning data further comprise indications of when the mobile device 20 was proximate particular landmarks.

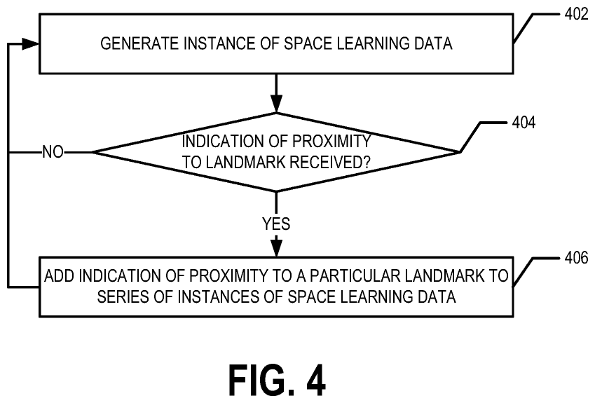

FIG. 4 provides a flowchart illustrating various processes, procedures, operations, and/or the like performed by the mobile device 20 to generate a series of instances of space learning data. Starting at block 402, the mobile device 20 generates an instance of space learning data. For example, the mobile device 20 comprises means, such as processor 22, memory 24, sensors 29, and/or the like for generating an instance of space learning data. In an example embodiment, the mobile device 20 generates instances of space learning data on a periodic basis (e.g., every second, every five seconds, every ten seconds, every twenty seconds, every thirty seconds, every minute, every minute and a half, every two minutes, every five minutes, and/or the like). In an example embodiment, the mobile device 20 generates an instance of space learning data responsive to determining that the mobile device 20 has moved at least a trigger distance from a previous position of the mobile device (e.g., two meters, five meters, ten meters, twenty meters), the heading or orientation of the mobile device changes by at least a trigger angle (e.g., 45°, 60°, 90°, and/or the like). In various embodiments, an instance of space learning data comprises an instance of radio data and an associated position estimate. In various embodiments, an instance of radio data generated when a mobile device 20 is located at a first location comprises an access point identifier, a received signal strength indicator, a one-way or round trip time for communicating with the access point, a transmission channel or frequency of the access point, a transmission interval (e.g., how frequently the access points generates, transmits, broadcasts, and/or the like a signal) and/or the like for each access point observed by the mobile device 20 at the first location. In various embodiments, the instance of radio data and/or the associated position estimate is stored in association with a time stamp indicating the date and/or time when the mobile device 20 was located at the first location and generated the instance of radio data.

At block 404, it is determined whether an indication that the mobile device 20 is located proximate a landmark. For example, the mobile device 20 determines whether an indication that the mobile device is proximate a landmark. For example, the mobile device 20 comprises means, such as processor 22, memory 24, user interface 28, sensors 29, and/or the like, for determining whether an indication that the mobile device is proximate a landmark. In various embodiments, it is determined that the mobile device 20 proximate a particular landmark when a user interacts with a GUI displayed via the user interface 28 to provide input indicating that the mobile device 20 is proximate the particular landmark. For example, the user may determine that mobile device (and the user) are proximate the particular landmark. In various embodiments, it is determined that the mobile device is proximate a particular landmark when analysis and/or processing of sensor data captured by sensors 29 of the mobile device 20 (e.g., by a landmark identification application operating on the mobile device 20) identifies the respective landmark description within the sensor data. The landmark identification application may then provide an indication (e.g., to the processor 22 and/or a space learning data generating application being executed by the processor 22) that the mobile device 20 is located proximate the particular landmark.

When it is determined, at block 404, that the mobile device 20 is not located proximate a landmark, the process returns to block 402 to generate another instance of space learning data. When it is determined, at block 404, that the mobile device is located proximate a particular landmark, the process continues to block 406.

At block 406, a landmark proximity indication of the mobile device being proximate a particular landmark is added to the series of instances of space learning data. For example, the mobile device 20 stores an landmark proximity indication of the mobile device being proximate the particular landmark to the series of instances of space learning data. For example, the mobile device 20 comprises means, such as processor 22, memory 24, and/or the like, storing an landmark proximity indication of the mobile device 20 being proximate the particular landmark to the series of instances of space learning data. For example, the landmark proximity indication of the mobile device being proximate the particular landmark may include a landmark identifier configured to identify the particular landmark, a time stamp indicating the date and/or time when it was determined the mobile device 20 was located proximate the particular landmark, a position estimate of the mobile device 20 when it was determined that the mobile device 20 was located proximate the particular landmark. In an example embodiment, an instance of radio data is also associated with the position estimate of the landmark proximity indication. For example, an instance of radio data may be generated when the mobile device 20 is located proximate the particular landmark, in an example embodiment. In various embodiments, the position estimate of the landmark proximity indication indicating the mobile device 20 being located proximate the particular landmark is used as a position estimate of the particular landmark when determining a reference and/or known location corresponding to the particular landmark.

Once the landmark proximity indication of the mobile device being proximate the particular landmark is added to the series of instances of space learning data, the process returns back to block 402 to generate additional instances of space learning data.

In various embodiments, the mobile device 20 also monitors the GNSS sensor of the mobile device 20 to determine when a GNSS-based position estimate having an appropriate accuracy is available and/or can be determined. When it is determined that a GNSS-based position estimate having an appropriate accuracy is available and/or can be determined, the GNSS-based position estimate is determined and a reference and/or known location indication is added to the series of instances of space learning data. In various embodiments, the indication of a reference and/or known location comprises a flag or other indication that the position estimate is a GNSS-determined position estimate, the position estimate, and, possibly, a timestamp indicating the date and/or time when the position estimate was determined. In various embodiments, the position estimate of the reference and/or known location indication is geolocation (e.g., latitude and longitude; latitude, longitude, and altitude/elevation; and/or the like). In various embodiments, the reference and/or known location indication is added to and/or stored to the series of instances of space learning data.

Exemplary Generating of an Instance of Space Learning Data

As noted above, in various embodiments, an instance of space learning data comprises an instance of radio data associated with a respective position estimate and, possibly, a respective time stamp. In various embodiments, the instance of radio data comprises an access point identifier, a received signal strength indicator, a one-way or round trip time for communicating with the access point, a transmission channel or frequency of the access point, a transmission interval (e.g., how frequently the access points generates, transmits, broadcasts, and/or the like a signal) and/or the like for each access point observed by the mobile device 20 when the mobile device was located at a respective location. The position estimate associated with the instance of radio data is an estimate of the position of the respective location. In various embodiments, the position estimate is a geolocation (e.g., a latitude and longitude; a latitude, longitude, and altitude/elevation; and/or the like). In an example embodiment, the position estimate is a description of the motion of the mobile device 20 since the last position estimate was generated (e.g., moved five meters at a heading of 90° with respect to magnetic North). In an example embodiment, the time stamp indicates a date and/or time at which the mobile device 20 was located at the respective location and observed the access points identified in the instance of radio data.

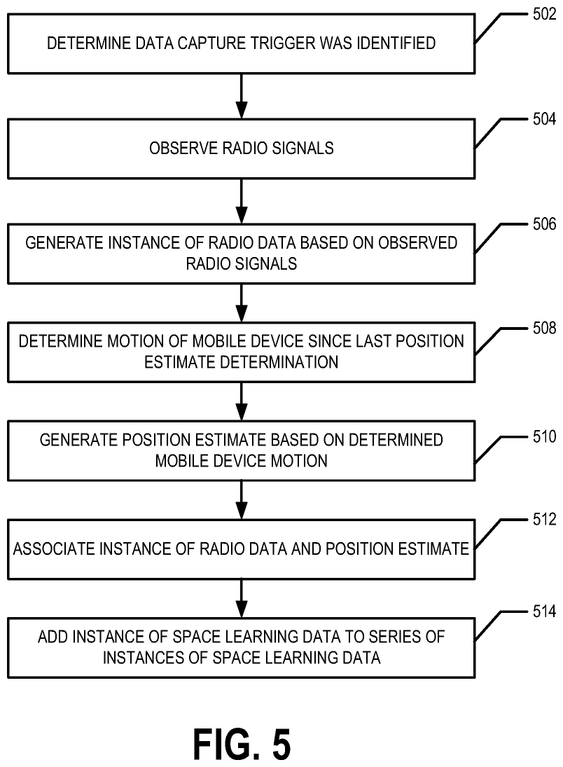

FIG. 5 provides a flow chart illustrating various processes, procedures, operations, and/or the like that may be performed to generate an instance of space learning data. For example, the processes, procedures, operations, and/or the like shown in FIG. 5 may occur during block 402 of FIG. 4. Starting at block 502, it is determined that a data capture trigger was identified. For example, the mobile device 20 determines that a data capture trigger was identified. For example, the mobile device 20 comprises means, such as processor 22, memory 24, sensors 29, and/or the like, for determining that a data capture trigger was identified. For example, the mobile device 20 may determine that a certain amount of time (e.g., one second, five seconds, ten seconds, twenty seconds, thirty seconds, one minute, a minute and a half, two minutes, five minutes, and/or the like) has elapsed since the last instance of space learning data was captured and, based thereon, determine that a data capture trigger was identified. In another example, the mobile device 20 may determine that the mobile device 20 has moved a certain distance since the previous instance of space learning data was captured and the certain distance is at least a trigger distance device (e.g., two meters, five meters, ten meters, twenty meters) and therefore determine that a data capture trigger was identified. In another example, the mobile device 20 may determine that the mobile device 20 has changed heading and/or orientation by a certain angle since the previous instance of space learning data was captured and the certain angle is at least a trigger angle (e.g., 45°, 60°, 90°, and/or the like) and therefore determine that a data capture trigger was identified.

At block 504, the mobile device 20 observes one or more radio frequency signals. For example, the mobile device 20 comprises means, such as processor 22, memory 24, sensors 29, and/or the like for observing one or more radio frequency signals. In an example embodiment, the one or more radio frequency signals may be Wi-Fi signals, Bluetooth or Bluetooth Lite signals, cellular signals, and/or other radio frequency signals present at the respective location of the mobile device 20 with a received signal strength that satisfies the detection threshold of at least one of the sensors 29. While and/or based on observing the one or more radio frequency signals, the mobile device 20 may determine an access point identifier for each of one or more access points that each generated at least one of the one or more observed radio frequency signals. While and/or based on observing the one or more radio frequency signals, the mobile device 20 may determine one or more characterizations for respective ones of the one or more observed signals. For example, the one or more characterizations an observed radio frequency signal may include a received signal strength, a one-way or round trip time for communicating with the respective access point, a transmission channel or frequency of the access point, a transmission interval (e.g., how frequently the access points generates, transmits, broadcasts, and/or the like a signal) and/or the like.

At block 506, the mobile device 20 generates the instance of radio data based on the radio frequency signals observed at the respective location. For example, the mobile device 20 comprises means, such as processor 22, memory 24, and/or the like, for generating the instance of radio data based on the radio frequency signals observed at the respective location. For example, the mobile device may format the access point identifiers and respective one or more characterizations for the one or more observed signals into a predetermined and/or set format to generate the instance of radio data. In various embodiments, an instance of radio data generated at a respective location comprises an access point identifier, a received signal strength indicator, a one-way or round trip time for communicating with the access point, a transmission channel or frequency of the access point, a transmission interval (e.g., how frequently the access points generates, transmits, broadcasts, and/or the like a signal) and/or the like for each access point observed by the mobile device 20 at the respective location.

At block 508, the mobile device 20 determines the motion of the mobile device since the previous and/or last instance of space learning data was captured, generated, and/or the like. For example, the mobile device 20 comprises means, such as processor 22, memory 24, sensors 29, and/or the like for determining the motion of the mobile device since the previous and/or last instance of space learning data was captured, generated, and/or the like. For example, the motion sensors 29 may log and/or provide to the processor 22 information regarding the movement (e.g., steps, distance traveled, heading/orientation of the mobile device when the steps were taken/distance traveled, and/or the like) of the mobile device 20 since the previous and/or last instance of space learning data was captured, generated, and/or the like. For example, the motion and/or IMU sensors 29 may determine and/or generate signals that may be used (e.g., by the processor 22) to determine the motion of the mobile device 20 since the previous and/or last instance of space learning data was captured, generated, and/or the like.

At block 510, the mobile device 20 generates a position estimate estimating the position of the mobile device 20 when the mobile device 20 is located at the respective location. For example, the mobile device 20 comprises means, such as processor 22, memory 24, and/or the like for generating a position estimate estimating the position of the mobile device 20 when the mobile device was located at the respective location. In an example embodiment, the generated position estimate comprises an absolute position estimate such as a geolocation (e.g., a latitude and longitude; a latitude, longitude, and altitude/elevation; and/or the like). In an example embodiment, the position estimate comprises a description of the motion of the mobile device 20 since the previous and/or last position estimate was generated (e.g., moved five meters at a heading of 90° with respect to magnetic North). For example, in various embodiments, the position estimate comprises information regarding a path portion that the mobile device 20 traversed between the capturing and/or generating of the previous instance of space learning data and the respective location of the mobile device 20 when the current instance of space learning data was captured and/or generated. In various embodiments, the position estimate is determined at least in part based on the determined motion of the mobile device since the previous and/or last instance of space learning data was captured, generated, and/or the like.

At block 512, the mobile device 20 generates instance of space learning data by associating the instance of radio data with the position estimate (and possibly a time stamp). For example, the mobile device 20 comprises means, such as processor 22, memory 24, and/or the like, for generating the instance of space learning data by associating the instance of radio data with the position estimate. For example, the position estimate may be added to the instance of radio data, to associate the position estimate with the instance of radio data, in an example embodiment. In another example, both the instance of radio data and the position estimate are indexed by the same instance identifier and/or the same (or similar) time stamp, to associate the position estimate with the instance of radio data.

At block 514, the mobile device 20 adds and/or stores the instance of space learning data to the series of instances of space learning data. For example, the mobile device 20 comprises means, such as processor 22, memory 24, and/or the like for adding and/or storing the instance of space learning data to the series of instances of space learning data. For example, the series of instances of space learning data may be stored as a space learning database and the instance of space learning data may be added to the database. For example, the instance of space learning data may be added and/or stored to a space learning database by adding a new instance of space learning data record to the database, adding one or more lines to a table storing the series of instances of space learning data, and/or the like.

Exemplary Determining that the Mobile Device is Located Proximate a Particular Landmark

In various embodiments, an landmark proximity indication of the mobile device's 20 proximity to a particular landmark is added to the series of instances of space learning data responsive to a determination that the mobile device 20 is located proximate the particular landmark. In various embodiments, the determination that the mobile device 20 is located proximate the particular landmark is determined based on user input (e.g., via the user interface 28). In various embodiments, the determination that the mobile device 20 is located proximate the particular landmark is determined based on analyzing and/or processing sensor data captured by one or more sensors 29 of the mobile device 20.

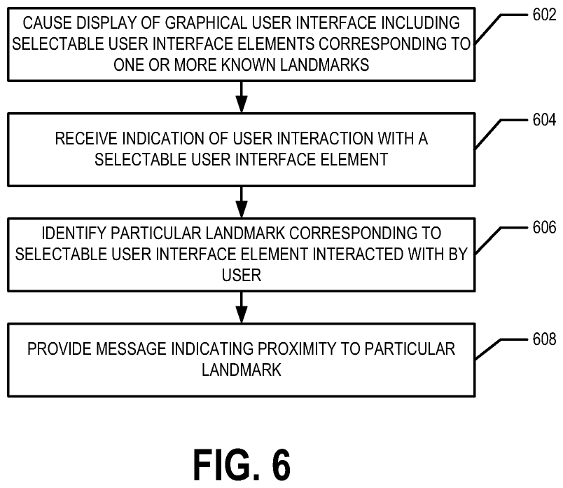

FIG. 6 provides a flowchart illustrating various processes, procedures, operations, and/or the like performed (e.g., by the mobile device 20) to provide an landmark proximity indication of the proximity of the mobile device 20 to a particular landmark based on user input. In various embodiments, the mobile device 20 is configured to provide a GUI via the user interface 28 of the mobile device 20. When the user determines that the user (and the mobile device) are located proximate a particular landmark, the user interacts with the GUI (e.g., via the user interface 28) to provide an landmark proximity indication that the mobile device 20 is located proximate the particular landmark. For example, the GUI may comprise a selectable user interface element corresponding to each known and/or defined landmark within the space. For example, the selectable user interface element corresponding to a particular landmark may include at least a portion of the description of the particular landmark (e.g., a textual description of the particular landmark, a digital image of the particular landmark, and/or the like).

When the user determines that the user (and the mobile device 20) is located proximate the particular landmark, the user may interact, select, and/or the like the selectable user interface element corresponding to the particular landmark to cause an landmark proximity indication of the proximity of the mobile device 20 to the particular landmark to be added to the series of instances of space learning data. In various embodiments, the user may determine that the user (and the mobile device) are located proximate the particular landmark when the user can see the particular landmark, when the user is within a threshold distance of the particular landmark (e.g., twenty meters, ten meters, five meters, one meter, and/or the like), when the user can reach out and touch the particular landmark, and/or the like. In an example embodiment, the user determines that the user (and the mobile device 20) are proximate a particular landmark when the user determines that the user is as close to the particular landmark as the user will get during a current pass by the particular landmark. In various embodiments, the determination that the user (and the mobile device 20) are located proximate the particular landmark is subject to the user's discretion. For example, the process, procedures, operations, and/or the like described with respect to FIG. 6 may occur simultaneous to and/or as part of the processes, procedures, operations, and/or the like described with respect to FIG. 4.

Starting at block 602, a GUI is provided via the user interface 28 of the mobile device 20. For example, the mobile device 20 comprises means, such as processor 22, memory 24, user interface 28, and/or the like to cause a GUI to be provided via the user interface 28. In an example embodiment, a space learning data generating application being executed by the processor 22 causes the user interface 28 to provide (e.g., display) the GUI via display thereof. In various embodiments, the GUI comprises one or more selectable user interface elements each corresponding to a defined landmark within the space. For example, the selectable user interface element corresponding to a particular landmark comprises and/or displays at least a portion of the description of the particular landmark. For example, the selectable user interface element comprises or displays a textual description of the particular landmark, in an example embodiment. In another example, the selectable user interface element comprises or displays at least a portion of digital image of the particular landmark. The portion of the digital image of the particular landmark includes enough context and/or background that the user can determine when the user (and the mobile device 20) are located proximate the particular landmark.

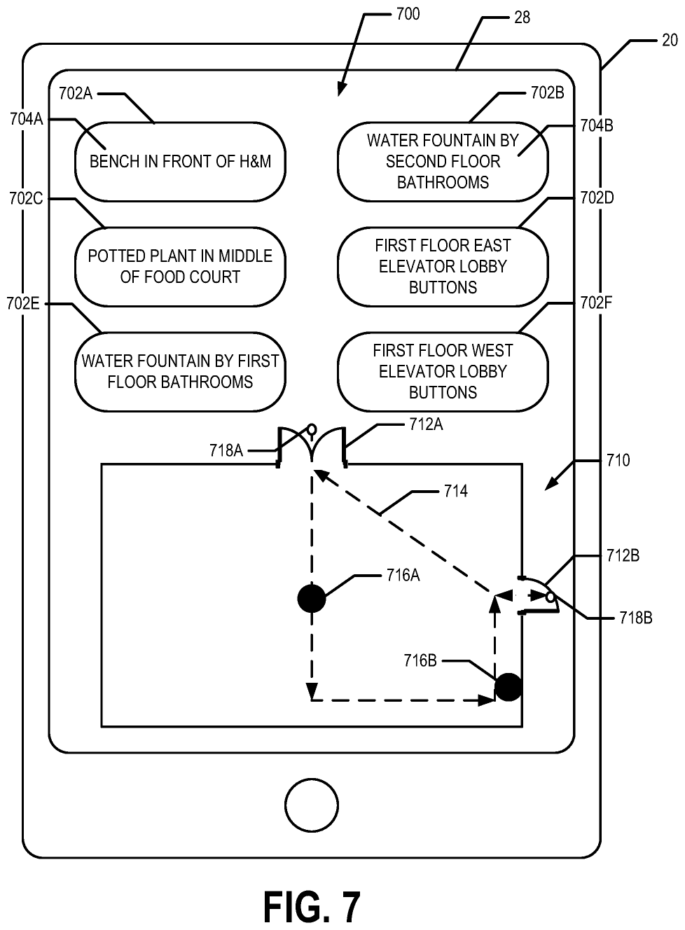

FIG. 7 provides an example view of a GUI 700 displayed by the user interface 28 of the mobile device 20 that is configured for receiving user input indicating the user (and the mobile device 20) are located proximate a particular landmark. The GUI 700 comprises one or more selectable user interface elements 702 (e.g., 702A-F). Each of the selectable user interface elements corresponds to one of the known landmarks defined within the space and comprises at least a portion of the description (e.g., textual and/or visual description) of the corresponding landmark. For example, a first selectable user interface element 702A comprises a first textual description 704A corresponding to a first landmark defined with the space and a second selectable user interface element 702B comprises a second textual description 704B corresponding to a second landmark defined within the space. In various embodiments, the description 704 (visual and/or textual) displayed by a selectable user interface element 702 of the GUI is configured to enable the user to determine when the user is proximate the corresponding landmark defined within the space.

In the illustrated embodiment, the GUI 700 further comprises a map portion 710 that displays at least a portion of a map of the space. In an example embodiment, the map is known before the space learning process begins. In an example embodiment, the map is generated during the space learning process based at least in part on the movement of the mobile device 20 through the space. For example, the mobile device 20 may be able to obtain and/or determine a GNSS-based position estimate when outside of the space, such that reference and/or known locations 718A, 718B are defined based on GNSS-based position estimates determined by the mobile device 20. In an example embodiment, the map portion 710 may comprise an landmark proximity indication of where known doors 712 (e.g., 712A, 712B) are located such that the user may return to reference and/or known location 718 as desired and/or required. In an example embodiment, the map portion 710 comprises a path 714 indicating the path traversed through the space by the mobile device 20 as determined based on the motion and/or IMU sensor data generated by the mobile device 20 as the mobile device 20 moves through the space. In an example embodiment, the map portion 710 further comprises a landmark indicator 716 (e.g., 716A, 716B) for one or more landmarks that the mobile device 20 has passed by and/or has been proximate to as the mobile device 20 moves through the space. An example embodiment of the GUI 700 does not include a map portion 710. For example, a map of the space may not be known and may not be determined during the space learning process (e.g., in real time or near real time with the performance of the space learning process).

Continuing with FIG. 6, at block 604, an indication of user interaction with one of the one or more selectable user interface elements is received. For example, the mobile device 20 receives an indication of user interaction with one of the one or more selectable user interface elements. For example, the mobile device 20 comprises means, such as processor 22, memory 24, user interface 28, and/or the like, for receiving an indication of user interaction with the one or more selectable user interface elements. For example, as the user moves through the space, the user may determine that they are proximate a particular landmark and select, press, touch, and/or the like the selectable user interface element 702 corresponding to the particular landmark and including (e.g., displaying) the description 704 which describes the particular landmark. The user interface 28 of the mobile device 20 registers the user interaction with the selectable user interface element 702 and provides an indication of the user interaction with the selectable user interface element 702 to the processor 22. The processor 22 (and/or a backend of the GUI being executed by the processor 22) receives the indication of the user interaction with the selectable user interface element 702.

At block 606, the mobile device 20 determines which known landmark the user selected. For example, the mobile device 20 comprises means, such as processor 22, memory 24, and/or the like, for determining which known landmark the user selected For example, the backend of the GUI being executed by the processor 22 may receive an indication that a particular selectable user interface element was selected. The backend of the GUI may then determine that the particular selectable user interface element corresponds to a particular landmark of the known landmarks. For example, each selectable user interface element 702 may be associated with a landmark identifier. When the user selects and/or interacts with a particular selectable user interface element 702, the space learning data generating application may receive the particular landmark identifier as part of an indication of the user interaction with the particular selectable user interface element 702. The backend of the GUI may then determine and/or identify that the particular landmark identified by the particular landmark identifier was selected.

At block 608, the backend of the GUI generates and provides a message indicating that the mobile device 20 was located proximate the particular landmark. For example, the backend of the GUI (e.g., operating on the mobile device 20) generates and provides a message that is received by the space learning data generating application (e.g., operating on the mobile device 20). In an example embodiment, the message comprises a landmark identifier configured to identify the particular landmark, a timestamp indicating when the indication of user input was received (e.g., by the backend of the GUI), and/or the like. For example, the mobile device 20 comprises means, such as processor 22, memory 24, and/or the like for providing (e.g., by the backend of the GUI) and/or receiving (e.g., by the space learning data generating application) a message indicating that the mobile device 20 was proximate the particular landmark.

Responsive to receiving the message indicating that the mobile device 20 was located proximate the particular landmark, an landmark proximity indication that the mobile device 20 was located proximate the particular landmark is generated and added and/or stored to the series of instances of space learning data. For example, the mobile device 20 generates an landmark proximity indication that the mobile device was located proximate the particular landmark and adds and/or stores the landmark proximity indication to the series of instances of space learning data (e.g., in memory 24). For example, the mobile device 20 comprises means, such as processor 22, memory 24, and/or the like, for generating an landmark proximity indication that the mobile device 20 was proximate the particular landmark and adding and/or storing the landmark proximity indication to the series of instances of space learning data.

For example, the landmark proximity indication of the mobile device being proximate the particular landmark may include the particular landmark identifier configured to identify the particular landmark, a time stamp indicating the date and/or time when the mobile device 20 was located proximate the particular landmark, a position estimate of the mobile device 20 when the mobile device 20 was located proximate the particular landmark, and/or the like. In an example embodiment, an instance of radio data is also associated with the landmark proximity indication and/or the position estimate of the landmark proximity indication. For example, an instance of radio data may be generated when the mobile device 20 is located proximate the particular landmark, in an example embodiment. In various embodiments, the position estimate of the landmark proximity indication indicating the mobile device 20 being located proximate the particular landmark is used as a position estimate of the particular landmark when determining a reference and/or known location corresponding to the particular landmark.

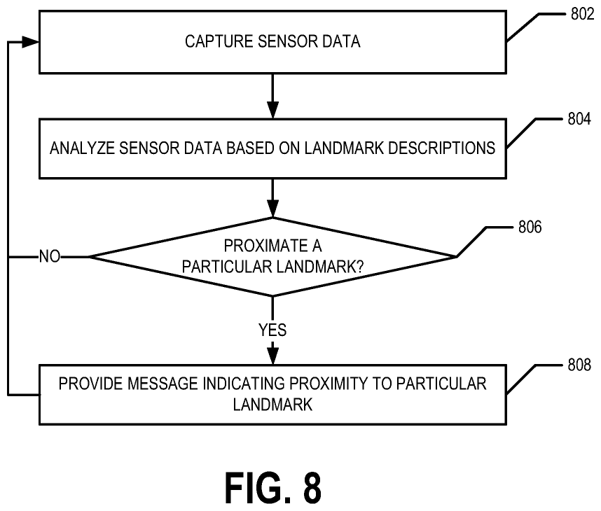

FIG. 8 provides a flowchart illustrating various processes, procedures, operations, and/or the like that may be performed (e.g., by a mobile device 20) to automatically identify when the mobile device 20 is proximate a known landmark and add an landmark proximity indication of the mobile device being proximate the known landmark to the series of instances of space learning data. In various embodiments, the user carries the mobile device 20 and/or the mobile device 20 is mounted, secured, and/or otherwise disposed in a position where the sensors 29 of the mobile device 20 can capture sensor data as the mobile device 20 moves through the space. In various embodiments, the sensors 29 capture sensor data and one or more landmark identifying applications operating on the mobile device 20 (e.g., being executed by processor 22) analyze and/or process the sensor data periodically, regularly, and/or continuously as the mobile device 20 moves through the space to determine when the mobile device 20 is proximate a known landmark.

For example, visual sensors capture visual/image data, audio sensors capture audio data, and/or LiDAR and/or RADAR sensors capture point cloud data such that the sensors 29 of the mobile device capture and/or generate sensor data. In various embodiments, different sensors 29 of the mobile device may capture and/or generate sensor data with the same or different sampling rates, as appropriate for the application. The image data, audio data, and/or point cloud data is processed and/or analyzed by one or more landmark identifying applications (e.g., operating on the mobile device 20) based on the descriptions of the known landmarks. When it is determined that the captured sensor data comprises a landmark signature (e.g., sensor data that matches a particular landmark description by at least a threshold confidence level), it is determined that the mobile device 20 is located near, and possibly proximate, the particular landmark.

In an example embodiment, it is determined, by the mobile device 20, that the mobile device is located proximate the particular landmark each time that the landmark signature corresponding to the particular landmark is identified within the captured sensor data. In an example embodiment, it is determined, by the mobile device, that the mobile device is located proximate the particular landmark the first time within a threshold amount of time (e.g., one minute, two minutes, three minutes, five minutes, and/or the like) that the landmark signature corresponding to the particular landmark is identified within the captured sensor data. In an example embodiment, the mobile device 20 determines that the mobile device is located proximate the particular landmark when the sensor data indicates that the mobile device is closest to the particular landmark during a pass by the particular landmark. For example, four instances of sensor data, each corresponding to a time step, may comprise a landmark signature for the particular landmark on a particular pass by the particular landmark. Captured at a first time, the first instance of sensor data indicates that the mobile device is located twenty meters from the particular landmark. Captured at a second time, the second instance of sensor data indicates that the mobile device is located twelve meters from the particular landmark. Captured at a third time, the third instance of sensor data indicates that the mobile device is located six meters from the particular landmark. Captured at a fourth time, the fourth instance of sensor data indicates that the mobile device is located ten meters from the particular landmark. Thus, the third time is identified as the time that the mobile device 20 was located proximate the particular landmark. In another example embodiment, the mobile device 20 determines that the mobile device is located proximate the particular landmark when the captured sensor data indicates that the mobile device is within a threshold distance (e.g., ten meters, eight meters, five meters, three meters, two meters, one meter, and/or the like) of the particular landmark. As the user participated in defining the known landmarks, the user is aware of the known landmarks and may ensure when the user (and the mobile device 20) passes by the particular landmark, the user passes within the threshold distance of the particular landmark.

Starting at block 802, the mobile device 20 captures sensor data. For example, the mobile device comprises means, such as processor 22, memory 24, sensors 29, and/or the like, for capturing sensor data. For example, the mobile device 20 may use visual sensors to capture visual/image data, audio sensors to capture audio data, LiDAR and/or RADAR sensors to capture point cloud data, and/or the like. In various embodiments, the mobile device 20 captures sensor data periodically (e.g., every second, every ten seconds, every fifteen seconds, every twenty seconds, every thirty seconds, every minute, every minute and a half, and/or the like). In an example embodiment, the mobile device 20 captures sensor data (image data, audio data, point cloud data, and/or the like) responsive to the motion and/or IMU sensors indicating that the mobile device 20 has moved a trigger distance (e.g., two meters, five meters, ten meters, twenty meters) since the previous sensor data capture.

At block 804, the sensor data (e.g., image data, audio data, point cloud data, and/or the like) is analyzed and/or processed by one or more landmark identifying applications (e.g., operating on the mobile device 20) based on the descriptions of the known landmarks. For example, the mobile device 20 analyzes and/or processes the sensor data based on descriptions of the known landmarks to determine whether and/or when a landmark signature corresponding to a particular landmark is present within the sensor data. For example, the mobile device 20 comprises means, such as processor 22, memory 24, and/or the like, for analyzing and/or processing the sensor data to determine whether and/or when a landmark signature corresponding to a particular landmark is present within the sensor data. For example, the sensor data is processed (e.g., via a natural language processing model to extract words or text, point cloud segmentation to identify features represented by the point cloud, filtering, feature extraction via a feature detector or a machine learning-trained feature classifier, and/or the like) to generate a sensor result which is then compared to respective description of one or more landmarks to determine whether the sensor result is a landmark signature (e.g., matches a description of a particular landmark), in an example embodiment.

At block 806, it is determined whether the sensor data indicates that the mobile device is located proximate a particular landmark. For example, the mobile device 20 may determine whether the sensor data indicates that the mobile device is located proximate a particular landmark. For example, the mobile device 20 comprises means, such as processor 22, memory 24, and/or the like, for determining whether the sensor data indicates that the user is located proximate a particular landmark. For example, when it is determined that the sensor data comprises a landmark signature corresponding to a particular landmark, the mobile device 20 may determine that the mobile device 20 is proximate the particular landmark, in an example embodiment. In various embodiments, when it is determined that the sensor data comprises a landmark signature corresponding to a particular landmark and one or more proximity criteria are satisfied (e.g., as indicated by the sensor data), the mobile device 20 determines that the mobile device is proximate the particular landmark, in an example embodiment. In various embodiments, the proximity criteria may include that the mobile device 20 reaches its closest approach to the particular landmark for a particular pass by the particular landmark, that the mobile device 20 is within a threshold distance of the particular landmark, and/or the like.

When it is determined, at block 806, that the mobile device 20 is not proximate a particular landmark, the process returns to block 802 and another instance of sensor data is captured. When it is determined, at block 806, the mobile device 20 is proximate a particular landmark, the process continues to block 808.

At block 808, the landmark identifying application (e.g., operating on the mobile device 20) provides a message to the space learning data generating application (e.g., operating on the mobile device) indicating that the mobile device is proximate a particular landmark. In various embodiments, the message includes a landmark identifier configured to identify the particular landmark. In an example embodiment, the message further includes a timestamp indicating a date and/or time when the mobile device 20 was located proximate the particular landmark. For example, the mobile device 20 comprises means, such as processor 22, memory 24, and/or the like for providing (e.g., by the landmark identifying application) and/or receiving (e.g., by the space learning data generating application) a message indicating that the mobile device 20 was proximate the particular landmark.

Responsive to receiving the message indicating that the mobile device 20 was located proximate the particular landmark, a landmark proximity indication indicating that the mobile device 20 was located proximate the particular landmark is generated and added and/or stored to the series of instances of space learning data. For example, the mobile device 20 generates an landmark proximity indication that the mobile device was located proximate the particular landmark and adds and/or stores the landmark proximity indication to the series of instances of space learning data (e.g., in memory 24). For example, the mobile device 20 comprises means, such as processor 22, memory 24, and/or the like, for generating an landmark proximity indication that the mobile device 20 was proximate the particular landmark and adding and/or storing the landmark proximity indication to the series of instances of space learning data.

For example, the landmark proximity indication of the mobile device being proximate the particular landmark may include the particular landmark identifier configured to identify the particular landmark, a time stamp indicating the date and/or time when the mobile device 20 was located proximate the particular landmark, a position estimate of the mobile device 20 when the mobile device 20 was located proximate the particular landmark, and/or the like. In various embodiments, the landmark proximity indication comprises and/or is associated with a position estimate corresponding to the time indicated by the timestamp provided by the message. In an example embodiment, an instance of radio data is also associated with the landmark proximity indication and/or the position estimate of the landmark proximity indication. For example, an instance of radio data may be generated when the mobile device 20 is located proximate the particular landmark, in an example embodiment. In various embodiments, the position estimate of the landmark proximity indication indicating the mobile device 20 being located proximate the particular landmark is used as a position estimate of the particular landmark when determining a reference and/or known location corresponding to the particular landmark.

Exemplary Use of a Series of Instances of Space Learning Data

In various embodiments, once the series of instances space learning data is generated and/or captured, the mobile device 20 provides the series of instances of space learning data to a network device 10 (e.g., via communications interface 26, in an example embodiment). The network device 10 (or the mobile device 20, in an example embodiment) analyzes and/or processes the series of instances of space learning data to generate (e.g., create, update, and/or the like) a radio map. At least a portion of the generated radio map corresponds to and/or provides map data corresponding to the space. In an example embodiment, the radio map is a radio positioning map that may be used to determine position estimates based on radio signals observed by a computing device.

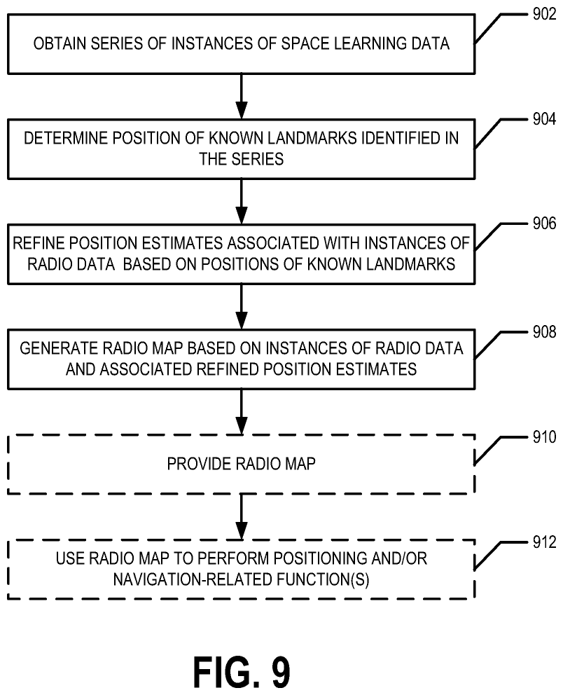

FIG. 9 provides a flowchart illustrating various processes, procedures, operations, and/or the like, performed by a network device 10, in various embodiments, to process a series of instances of space learning data, according to an example embodiment to generate and provide and/or use a radio map based thereon. Starting at block 902, a network device 10 obtains a series of instances of space learning data. For example, the network device 10 comprises means, such as processor 12, memory 14, communications interface 16, user interface 18, and/or the like, for obtaining a series of instances of space learning data. For example, the network device 10 may receive (e.g., via communications interface 16 and/or user interface 18) a series of instances of space learning data generated by a mobile device 20. The network device 10 may directly process the series of instances of space learning data upon receipt thereof (e.g., provide them directly to processor 12 for processing) or may store the series of instances of space learning data (e.g., in memory 14) for accessing and/or retrieving later for processing.

As described above, the series of instances of space learning data comprises a plurality of instances of space learning data, landmark proximity indications indicating the mobile device 20 being located proximate a respective landmark, and reference and/or known location indications indicating the mobile device 20 being located at a reference and/or known location (e.g., a location for which a GNSS-based position estimate is provided). In various embodiments, each instance of space learning data comprises an instance of radio data associated with a position estimate, and, possibly, associated with a timestamp. In various embodiments, an instance of radio data comprises an access point identifier, a received signal strength indicator, a one-way or round trip time for communicating with the access point, a transmission channel or frequency of the access point, a transmission interval (e.g., how frequently the access points generates, transmits, broadcasts, and/or the like a signal) and/or the like for each access point observed by the mobile device 20 when the mobile device was located at a respective location. In various embodiments, the associated position estimate corresponds to the respective location where the mobile device was located when the associated instance of radio data was generated. The position estimate comprises a geolocation (e.g., a latitude and longitude; a latitude, longitude, and altitude/elevation; and/or the like) and/or a description of the motion of the mobile device 20 since the last position estimate was generated, in various embodiments. In various embodiments, an landmark proximity indication indicating that the mobile device was located proximate a particular landmark comprises a landmark identifier configured to identify the particular landmark, a position estimate for the mobile device when the mobile device was located proximate the particular landmark, and possibly a timestamp. In various embodiments, a reference and/or known location indication comprises a GNSS-based position estimate and, possibly, a time stamp. In various embodiments, the instances of space learning data, landmark proximity indications, and reference and/or known location indications are time ordered so as to represent a path or trajectory of the mobile device 20 through at least a portion of the space to be learned.

Each instance of access point observation information comprises an instance of radio observation information and an instance of location information. The instance of radio observation information comprises one or more access point identifiers. Each access point identifier is configured to identify an access point that was observed by the respective mobile device 20. The instance of radio observation information further comprises information characterizing the respective observations of the one or more access points by the respective mobile device 20. For example, in an example embodiment, the instance of radio observation information comprises a signal strength indicator, a time parameter, and/or the like, each associated with a respective one of the one or more access point identifiers.

At block 904, position determinations for each of the known landmarks are determined. For example, the network device 10 determines a position determination for each of the known landmarks. For example, the network device 10 comprises means, such as processor 12, memory 14, and/or the like, for determining a position determination for each of the known landmarks.

To determine the position determination of a particular landmark, one or more landmark proximity indications comprising the landmark identifier configured to identify the particular landmark are identified from the series of instances of space learning data and the position estimates are extracted therefrom. The position determination for the particular landmark is then determined using a weighted average of the position estimates from when the mobile device 20 was located proximate the particular landmark. For example, the first position estimate is determined when the particular landmark is defined. When a k+1^{st} position estimate for the particular landmark is extracted from a landmark proximity indication, the position determination may be updated to generate a k+1^{st} position determination posₖ₊₁=wₖ·posₖ+w_{new}·pos_{new}/wₖ+w_{new}, were posₖ is the kth position determination, wₖ is a weight assigned to the kth position determination, pos_{new} is the new position estimate (e.g., the position estimate extracted from the landmark proximity indication), and w_{new} is a weight assigned to the new position estimate. In an example embodiment, both of the weights wₖ and w_{new} are set equal to one. In an example embodiment, the weight wₖ is determined based on a confidence level and/or uncertainty associated with the kth position determination posₖ and the weight w_{new} is determined based on a confidence level and/or uncertainty associated with the new (e.g., the k+1^{st}) position estimate.

In various embodiments, an uncertainty and/or confidence level with the position determination, a variance matrix for the position determination, and/or a covariance for the position determination may also be determined and/or updated. For example, the k+1^{st} update of the covariance matrix covₖ₊₁ corresponding to the position determination may be determined by

$${cov}_{k + 1} = \frac{{w}_{k} \cdot ( {cov}_{k} + p o {s}_{k} p o {s}_{k}^{T} ) + {w}_{n e w} \cdot {pos}_{n e w} \cdot {pos}_{n e w}^{T}}{{w}_{k} + {w}_{n e w}} - {pos}_{k + 1} \cdot {pos}_{k + 1} ,$$

where covₖ is the covariance matrix for the k^{th} position determination posₖ, and a superscript T indicates a transpose of the corresponding vector. As should be understood, the covariance matrix for a position determination describes the covariance of each of the position estimates that were used (e.g., averaged) to generate the position determination.

In an example embodiment, the position determination of the particular landmark continues to be learned based on each landmark proximity indication including a landmark identifier configured to identify the particular landmark. In an example embodiment, the position determination of the particular landmark continues to be learned until the uncertainty of the position determination satisfies a stop criteria. For example, when the uncertainty of the position determination of the particular landmark falls below a threshold uncertainty level, the network device 10 may stop learning, updating, and/or the like the position determination based on additional location proximity indications comprising the landmark identifier configured to identify the particular landmark.

In an example embodiment, a position determination for one or more known landmarks is performed by the mobile device 20 and/or network device 10 during the capturing and/or generating of the series of space learning data (e.g., in real time or near real time). For example, each time a landmark proximity indication is added to the series of instances of space learning data that includes a landmark identifier configured to identify a particular landmark, the position determination for the particular landmark may be updated. In an example embodiment, the position determination for the particular landmark is performed (e.g., by the mobile device 20 or the network device 10) after the series of instances of space learning data are learned.

At block 906, the position estimates associated with the instances of radio data are updated based on the position determinations for the known landmarks. For example, the network device 10 refines and/or updates the position estimates associated with the instances of radio data based on the position determinations for the known landmarks. For example, the network device 10 comprises means, such as processor 12, memory 14, and/or the like, for refining and/or updating the position estimates associated with the instances of radio data based on the position determinations for the known landmarks. For example, the position determinations of the known landmarks may be provided to a sensor fusion and/or motion-based process as reference and/or known locations such that the position estimates associated with the instances of radio data may be determined as locations on a path through the space that passes close to one or more landmarks between reference and/or known locations determined based on GNSS-based position estimates. For example, the position determinations for one or more of the known landmarks may be provided to the sensor fusion and/or motion-based process as reference and/or known locations and the sensor fusion and/or motion-based process refines and/or updates the position estimates of the series of instances of space learning data based on the motion of the mobile device between position estimates as determined by the motion and/or IMU sensors 29. In various embodiments, the refined and/or updated position estimates comprise geolocations (e.g., latitude and longitude or latitude, longitude, and altitude/elevation). For example, the landmark proximity indications and the reference and/or known location indications (and the corresponding position determinations) are used to anchor the path of the mobile device 20 as the mobile device moved through the space as indicted by the description of the motion of the mobile device 20 provided by the position estimates of the series of instances of space learning data.

In an example embodiment, the position estimates associated with the instances of radio data of the series of instances of space learning data are refined and/or updated (e.g., by the mobile device 20) during the capturing and/or generating of the series of space learning data (e.g., in real time or near real time) based on a position determination of one or more of the known landmarks that was current or up-to-date at the time the position estimate was refined and/or updated. For example, the path of the mobile device 20 through the space may be anchored based on a current position determination for a particular landmark each time the mobile device passes by the particular landmark. For example, the best understanding of the location of the particular landmark is used to anchor the path of the user (and the mobile device) through the space when the user (and the mobile device) pass proximate the particular landmark during the space learning process. In an example embodiment, the position determination for the particular landmark is performed (e.g., by the mobile device 20 or the network device 10) after the series of instances of space learning data are learned.

At block 908, the network device 10 generates a radio map corresponding to the space based at least in part on the instances of radio data and the respective refined and/or updated position estimates. For example, the network device 10 comprises means, such as processor 12, memory 14, and/or the like, for generating a radio map corresponding to the space based at least in part on the instances of radio data and the respective refined and/or updated position estimates. In an example embodiment, the radio map corresponds to and/or describes the radio environment for a geographic area comprising the space. For example, the radio map may indicate the location of one or more access points observed by the mobile device 20 in the space. In various embodiments, the radio map may comprise a radio model for one or more access points observed by the mobile device 20. In various embodiments, a radio model comprises a description of the expected received signal strength and/or timing parameters of signals emitted, transmitted, broadcasted, and/or generated by the respective access point at different points within the coverage area or broadcast area of the access point. In an example embodiment, the radio model describes the coverage area or broadcast area of the access point. In various embodiments, the access point locations and/or radio models are determined based on analyzing and/or processing the instances of radio data and their respective associated refined and/or updated position estimates. In an example embodiment, the radio map is generated and/or created from scratch based on the series of instances of space learning data. In an example embodiment, the radio map is updated based on the series of instances of space learning data.

At block 910, the network device 10 provides at least a portion of the radio map. For example, the network device 10 comprises means, such as processor 12, memory 14, communications interface 16, user interface 18, and/or the like, for providing at least a portion of the radio map (e.g., a tile of the radio map, a portion of the radio map corresponding to a particular building or venue). As described above, the radio map comprises describing the location of one or more access points and/or characterizing and/or describing the radio environment at various locations within the space. In an example embodiment, the network device 10 provides (e.g., transmits) at least a portion of the radio map such that one or more other network devices 10 and/or computing devices 30 receive the at least a portion of the radio map. The network devices 10 and/or computing devices 30 may then use the at least a portion of the radio map to perform radio-based positioning (e.g., determine a position estimate for a computing device 30 based on radio sensor data captured by the computing device 30) and/or to perform one or more positioning and/or navigation-related functions.

At block 912, the network device 10 uses the radio map to perform one or more positioning and/or navigation-related functions. For example, the network device 10 comprises means, such as processor 12, memory 14, communications interface 16, and/or the like, for using at least a portion of the radio map to perform one or more positioning and/or navigation-related functions. In an example embodiment, the network device 10 stores the at least a portion of the radio map in memory (e.g., memory 14) such that the network device 10 can use the at least a portion of the radio map to perform radio-based positioning (e.g., determine a position estimate for a computing device 30 based on radio sensor data captured by the computing device 30) and/or to perform one or more positioning and/or navigation-related functions. Some non-limiting examples of positioning and/or navigation-related functions include providing a route or information corresponding to a geographic area (e.g., via a user interface), localization, localization visualization, route determination, lane level route determination, operating a vehicle along at least a portion of a route, operating a vehicle along at least a portion of a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

In various embodiments, the radio map may be used to perform positioning and/or navigation-related functions. In various embodiments, the radio map may be used as the basis of a radio map that is improved, updated, and/or generated based on crowd-sourced radio observation data. For example, the access point locations and/or radio models determined based on the series of instances of space learning data may be used to seed a radio map generated based on crowd-sourced radio observation data.

In various embodiments, one or more steps, operations, processes, procedures, and/or the like described herein as being performed by the network device 10 are performed by a mobile device 20. For example, in an example embodiment, a mobile device 20 determines the position determination for one or more landmarks, refines and/or updates position estimates of the series of instances of space learning data, and/or the like.

Exemplary Operation of a Computing Device

In various embodiments, positioning for a computing device 30 and/or one or more positioning and/or navigation-related functions corresponding to the computing device 30 are performed by a network device 10 and/or the computing device 30 using a radio map generated at least in part based on the series of instances of space learning data. For example, a computing device 30 which may be onboard a vehicle, be physically associated with a pedestrian. and/or the like may be located within a geographic area associated with a radio map. For example, the computing device 30 may be located near and/or within the space. For example, the computing device 30 may be located within a building or venue corresponding to and/or defining the space. The computing device 30 may capture, generate, and/or determine an instance of radio observation information.

In various embodiments, an instance of radio observation information comprises a respective access point identifier for each of one or more access points observed by the computing device 30. In various embodiments, a computing device 30 observes an access point by receiving, detecting, capturing, measuring, and/or the like a signal (e.g., a radio frequency signal) generated by the access point. For example, a computing device 30 may determine an access point identifier, a received signal strength, a one-way or round trip time for communicating with the access point, a channel or frequency of the access point, a transmission interval, and/or the like based on the computing device's observation of the access point.

In various embodiments, an instance of radio observation information further includes one or more measurements characterizing the observation of an access point 40 by the computing device 30. For example, when the computing device 30 observes a first access point 40A, the instance of radio observation information comprises an access point identifier configured to identify the first access point 40A and one or more measurement values such as the signal strength indicator configured to indicate an observed signal strength of the observed radio frequency signal generated, broadcasted, transmitted, and/or the like by the first access point 40A; a one way or round trip time value for communication (one way or two way communication) between the first access point 40A and the computing device 30; a channel and/or frequency of transmission used by the first access point 40A; and/or the like characterizing the observation of the first access point 40A by the computing device 30.

The computing device 30 provides the instance of radio observation information to a positioning function operating on the computing device 30 and/or a network device 10. In various embodiments, the positioning function (operating on the computing device 30 and/or the network device 10) uses the instance of radio observation information and a radio map to determine a position estimate for the location of the computing device 30 when the computing device 30 generated, captured, determined, and/or the like the instance of radio observation information. The position estimate and the traversable network-aware positioning map may then be used (e.g., by the computing device 30 and/or network device 10) to perform one or more positioning and/or navigation-related functions.

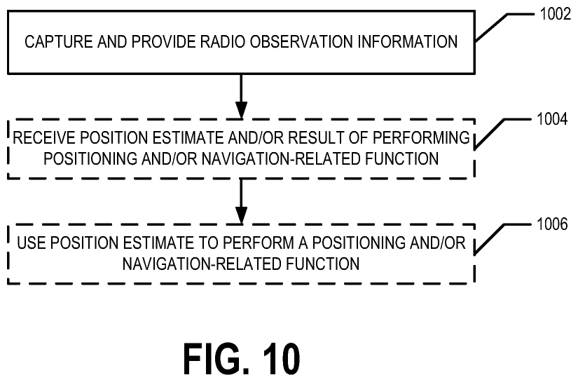

FIG. 10 provides a flowchart illustrating various processes, procedures, operations, and/or the like performed by a computing device 30 in conjunction with various embodiments. Starting at block 1002, the computing device 30 captures, determines, and/or generates an instance of radio observation information and provides the instance of radio observation information. For example, the computing device 30 comprises means, such as processor 32, memory 34, communications interface 36, sensors 39, and/or the like, for capturing, determining, and/or generating an instance of radio observation information and providing the instance of radio observation information. For example, the sensors 39 of the computing device 30 observe and/or detect radio frequency signals generated by one or more access points and information/data, measurements, and/or the like characterizing the observation and/or detection of the radio frequency signals is incorporated into an instance of radio observation information. The instance of radio observation information is then provided to a positioning function operating on the computing device 30 and/or a network device 10 via an application program interface (API) call, for example. When the positioning function is operating on the network device 10, providing the instance of radio observation information to the positioning function includes transmitting the instance of radio observation information such that the network device 10 receives the instance of radio observation information. The positioning function is configured to use the instance of radio observation information and a radio map (e.g., generated based at least in part on a series of instances of space learning data) to determine a position estimate for the location of the computing device 30 when the computing device 30 observed and/or detected the one or more radio frequency signals the observation and/or detection of which are characterized by the instance of radio observation information.

At block 1004, in an example embodiment, the computing device 30 receives a position estimate generated based on the instance of radio observation information and the radio map. For example, the computing device 30 comprises means, such as processor 32, memory 34, communications interface 36, and/or the like, for receiving a position estimate generated and/or determined by the positioning function based on the instance of radio observation information and the radio map. In an example embodiment, the network device 10 generates and/or determines the position estimate and uses the position estimate (and possibly the radio map) to perform a positioning and/or navigation-related function. The network device 10 may then provide (e.g., transmit) the position estimate and/or a result of the positioning and/or navigation-related function such that the computing device 30 receives the position estimate and/or the result of the positioning and/or navigation-related function. Some non-limiting examples of positioning and/or navigation-related functions include providing a route or information corresponding to a geographic area (e.g., via a user interface), localization, localization visualization, route determination, lane level route determination, operating a vehicle along at least a portion of a route, operating a vehicle along at least a portion of a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

At block 1006, in an example embodiment, the computing device 30 performs one or more positioning and/or navigation-related functions based on the position estimate and, possibly, a radio map. For example, the computing device 30 comprises means, such as processor 32, memory 34, communications interface 36, user interface 38, and/or the like, for performing one or more positioning and/or navigation-related functions based on the position estimate and, possibly, radio map. For example, the computing device 30 may display the position estimate on a representation of the space (e.g., a map of the space) via the user interface 38 of the computing device 30 and/or perform various other positioning and/or navigation-related functions based at least in part on the position estimate.

### III. Technical Advantages

Conventional space learning processes require either that a user carrying a mobile device or other data gathering platform returns to a location (e.g., outside) where a GNSS-based reference and/or known location may be determined at least once every five to ten minutes or that a user frequently selects the user's location on a map of the space. When the user needs to return to a location where a GNSS-based reference and/or known location can be determined at least once every five to ten minutes, the size of the space and the number of floors or levels of the space which can be learn is significantly affected. In other words, sensor fusion and/or motion-based processes for determining position estimates remain precise for only a short period of time. When a user needs to frequently select their position on a map of the space, an accurate and detailed map of the space is required and human imprecision leads to significant uncertainty in the resulting position estimates. Therefore, technical problems exist regarding how to accurately determine position estimates during a space learning process for a space where GNSS-based position estimates are not available for a significant portion of the space.

Various embodiments provide technical solutions to these technical problems. In various embodiments, a user at the beginning or prior to performing the space learning process and/or during the performance of the space learning process, defines landmarks within the space. Thus, the user is aware of the defined landmarks and can ensure the path the user takes through the space passes close to the defined landmarks multiple times. This enables the position determinations for the defined landmarks to be determined to small uncertainties and increases the usefulness of the position determinations for the defined landmarks as reference and/or known locations to which the path of the mobile device 20 through the space can be anchored.

Moreover, as the position determinations for the locations of the landmarks are determined based on multiple position estimates for the landmarks, the position estimates associated with instances of radio data may be determined to greater accuracy without requiring the user to return to a location where a GNSS-based position estimate is available at least once every five to ten minutes. Thus, various embodiments provide technical improvements that lead to more accurate radio maps being generated for a space. These more accurate radio maps enable the technical improvement of more accurate radio-based positioning. Thus, various embodiments provide technical solutions to technical problems present in the field of performing space learning processes and provide technical improvements to space learning processes that result in more accurate radio maps and more accurate radio-based positioning.

### IV. Example Apparatus

The network device 10, mobile device 20, and/or computing device 30 of an example embodiment may be embodied by or associated with a variety of computing entities including, for example, a navigation system including a global navigation satellite system (GNSS), a cellular telephone, a mobile or smart phone, a personal digital assistant (PDA), a watch, a camera, a computer, an Internet of things (IoT) item, and/or other device that can observe the radio environment (e.g., receive radio frequency signals from network access points) in the vicinity of the computing entity and/or that can store at least a portion of a radio map. Additionally or alternatively, the network device 10, mobile device 20, and/or computing device 30 may be embodied in other types of computing devices, such as a server, a personal computer, a computer workstation, a laptop computer, a plurality of networked computing devices or the like, that are configured to capture a series of space learning data, generate a radio map based on analyzing and/or processing a series of space learning data, using a radio map to perform one or more positioning and/or navigation-related functions, capturing radio observation information and/or the like. In an example embodiment, a mobile device 20 and/or a computing device 30 is a smartphone, tablet, laptop, PDA, and/or other mobile computing device and a network device 10 is a server that may be part of a Cloud-based computing asset and/or processing system.

In some embodiments, the processor 12, 22, 32 (and/or co-processors or any other processing circuitry assisting or otherwise associated with the processor) may be in communication with the memory device 14, 24, 34 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the network device 10, mobile device 20, and/or computing device 30 may be embodied by a computing entity and/or device. However, in some embodiments, the network device 10, mobile device 20, and/or computing device 30 may be embodied as a chip or chip set. In other words, the network device 10, mobile device 20, and/or computing device 30 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22, 32 may be embodied in a number of different ways. For example, the processor 12, 22, 32 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22, 32 may include one or more processing cores configured to perform independently. A multi-core processor may enable multiprocessing within a single physical package. Additionally or alternatively, the processor 12, 22, 32 may include one or more processors configured in tandem via the bus to enable independent execution of instructions, pipelining and/or multithreading.

In an example embodiment, the processor 12, 22, 32 may be configured to execute instructions stored in the memory device 14, 24, 34 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the network device 10, mobile device 20, and/or computing device 30 may include a user interface 18, 28, 38 that may, in turn, be in communication with the processor 12, 22, 32 to provide a graphical user interface (GUI) and/or output to the user, such as one or more selectable user interface elements that comprise at least a portion of a description of a respective known landmark, at least a portion of a radio map, a result of a positioning and/or navigation-related function, navigable routes to a destination location and/or from an origin location, and/or the like, and, in some embodiments, to receive an indication of a user input. As such, the user interface 18, 28, 38 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22, 32 (e.g., memory device 14, 24, 34 and/or the like).

The network device 10, mobile device 20, and/or computing device 30 may optionally include a communication interface 16, 26, 36. The communication interface 16, 26, 36 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, a network device 10, mobile device 20, and/or computing device 30 may comprise a component (e.g., memory 14, 24, 34, and/or another component) that stores a digital map (e.g., in the form of a geographic database) comprising a first plurality of data records, each of the first plurality of data records representing a corresponding traversable map element (TME). At least some of said first plurality of data records map information/data indicate current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location, a radio-based position estimate) to a point on a map, a lane of a lane network, and/or link, one or more localization features and a corresponding location of each localization feature, and/or the like. For example, the geographic database may comprise a radio map, such as a radio positioning map, comprising an access point registry and/or instances of access point information corresponding to various access points. For example, a geographic database may include road segment, segment, link, lane segment, or TME data records, point of interest (POI) data records, localization feature data records, and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the network device 10 may be configured to modify, update, and/or the like one or more data records of the geographic database. For example, the network device 10 may modify, update, generate, and/or the like map information/data corresponding to a radio map and/or TMEs, links, lanes, road segments, travel lanes of road segments, nodes, intersection, pedestrian walkways, elevators, staircases, and/or the like and/or the corresponding data records (e.g., to add or update updated map information/data including, for example, current traffic conditions along a corresponding TME; assign and/or associate an access point with a TME, lateral side of a TME, and/or representation of a building; and/or the like), a localization layer (e.g., comprising localization features), a registry of access points to identify mobile access points, and/or the corresponding data records, and/or the like.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network and/or other traversable network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

### V. Apparatus, Methods, and Computer Program Products

As described above, FIGS. 3, 4, 5, 6, 8, 9, and 10 illustrate flowcharts of a network device 10, mobile device 20, and/or computing device 30, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24, 34 of an apparatus employing an embodiment of the present invention and executed by the processor 12, 22, 32 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
generating, by a mobile device, a series of instances of space learning data, the series of instances of space learning data comprising instances of radio data captured as the mobile device traverses a path through at least a portion of a space, wherein each instance of radio data describes a radio environment observed by the mobile device at a respective location along the path;
determining, for each respective location, a position estimate based at least on motion of the mobile device determined based at least in part on signals generated by one or more motion sensors of the mobile device, wherein the position estimate is associated with a respective instance of radio data in the series of instances of space learning data;
receiving a message indicating that the mobile device is located proximate a particular landmark, the particular landmark being an arbitrary location within the space that is associated with at least one of a user-provided or sensor-defined landmark description; and
responsive to receiving the message indicating that the mobile device is located proximate the particular landmark, updating the series of instances of space learning data to include a landmark proximity indication indicating that a particular location along the path is proximate the particular landmark.

2. The method of claim 1, wherein, prior to generating the series of instances of space learning data, the method comprises receiving user input via a user interface of the mobile device defining at least one of the one or more known landmarks.

3. The method of claim 2, wherein defining the at least one of the one or more known landmarks comprises generating a first position estimate of the at least one of the one or more known landmarks and generating the respective landmark description.

4. The method of claim 1, wherein the position estimate for a respective location is determined based on a portion of the path the mobile device traversed, wherein at least one end of the portion of the path is a known location and the portion of the path is determined based at least in part on the signals generated by the one or more motion sensors of the mobile device.

5. The method of claim 4, wherein the known location is one of (a) a location where a GNSS-based position estimate that satisfies one or more quality criteria is available or (b) proximate a known landmark of the one or more known landmarks as indicated by the received message.

6. The method of claim 1, wherein a position determination for a location of the particular landmark is determined by a weighted average of position estimates determined based at least in part on motion of the mobile device as determined based at least in part on the signals generated by the one or more motion sensors.

7. The method of claim 1, wherein the position estimate for the respective location is determined using a sensor fusion process.

8. The method of claim 1, wherein the message indicating that the mobile device is located proximate the particular landmark is received responsive to user interaction with a user interface of the mobile device.

9. The method of claim 8, wherein the user interacts with the user interface by selecting a selectable user interface element of a graphical user interface displayed via the user interface of the mobile device, the selected selectable user interface element corresponding to the particular landmark.

10. The method of claim 9, wherein the selected selectable user interface element comprises at least one of an image or a text description of the particular landmark, the at least one of the image or the text description being at least a portion of the respective landmark description.

11. The method of claim 1, wherein the message indicating that the mobile device is located proximate the particular landmark is received based on a determination that at least one sensor of the mobile device captured sensor data comprising the particular landmark based at least in part on the respective landmark description.

12. The method of claim 11, wherein the particular landmark is a text string or computer detectable feature that is unique within the space.

13. The method of claim 1, wherein the space comprises a building or venue and the series of instances of space learning data are configured for use in preparing or updating a radio map of the building or venue.

14. A mobile device comprising at least one processor, at least one memory storing computer program instructions, one or more motion sensors, and one or more radio sensors, the at least one memory and the computer program code are configured to, with the at least one processor, cause the mobile device to at least:
generate a series of instances of space learning data, the series of instances of space learning data comprising instances of radio data captured via the one or more radio sensors as the mobile device traverses a path through at least a portion of a space, wherein each instance of radio data describes a radio environment observed by the mobile device at a respective location along the path;
determine a position estimate based at least on motion of the mobile device determined based at least in part on signals generated by the one or more motion sensors, wherein the position estimate is associated with a respective instance of radio data in the series of instances of space learning data;
receive a message indicating that the mobile device is located proximate a particular landmark, the particular landmark being an arbitrary location within the space that is associated with at least one of a user-provided or sensor-defined landmark description; and
responsive to receiving the message indicating that the mobile device is located proximate the particular landmark, update the series of instances of space learning data to include a landmark proximity indication indicating that a particular location along the path is proximate the particular landmark.

15. The mobile device of claim 14, wherein the mobile device further comprises a user interface and, prior to generating the series of instances of space learning data, the at least one memory and the computer program code are further configured to, with the processor, cause the mobile device to at least receive user input via the user defining at least one of the one or more known landmarks.

16. The mobile device of claim 15, wherein defining the at least one of the one or more known landmarks comprises generating a first position estimate of the at least one of the one or more known landmarks and generating the respective landmark description.

17. The mobile device of claim 14, wherein the position estimate for a respective location is determined based on a portion of the path the mobile device traversed, wherein at least one end of the portion of the path is a known location and the portion of the path is determined based at least in part on the signals generated by the one or more motion sensors of the mobile device.

18. The mobile device of claim 14, wherein mobile device further comprises a user interface and the message indicating that the mobile device is located proximate the particular landmark is received responsive to user interaction with the user interface.

19. The mobile device of claim 14, wherein the mobile device further comprises at least one sensor and the message indicating that the mobile device is located proximate the particular landmark is received based on a determination that the at least one sensor captured sensor data comprising the particular landmark based at least in part on the respective landmark description.

20. A computer program product comprising at least one non-transitory computer-readable storage medium having computer-readable program instructions portions stored therein, the computer-readable program instruction portions comprise executable portions configured, when executed by a processor of a mobile device, to cause the mobile device to:
generate a series of instances of space learning data, the series of instances of space learning data comprising instances of radio data captured via one or more radio sensors of the mobile device as the mobile device traverses a path through at least a portion of a space, wherein each instance of radio data describes a radio environment observed by the mobile device at a respective location along the path;
determine a position estimate based at least on motion of the mobile device determined based at least in part on signals generated by one or more motion sensors of the mobile device, wherein the position estimate is associated with a respective instance of radio data in the series of instances of space learning data;
receive a message indicating that the mobile device is located proximate a particular landmark, the particular landmark being an arbitrary location within the space that is associated with at least one of a user-provided or sensor-defined landmark description; and
responsive to receiving the message indicating that the mobile device is located proximate the particular landmark, update the series of instances of space learning data to include a landmark proximity indication indicating that a particular location along the path is proximate the particular landmark.
